(19) United States
(12) Patent Application Publication
(10) Pub. No.: US 2015/0339901 A1
(43) Pub. Date: Nov. 26, 2015

(54) DESIGN-FIRST DISTRIBUTED REAL-TIME RFID TRACKING SYSTEM

(71) Applicant: CURTIS LEE SHULL, FAYETTEVILLE, TN (US)

(72) Inventor: CURTIS LEE SHULL, FAYETTEVILLE, TN (US)

(21) Appl. No.: 14/717,847

(22) Filed: May 20, 2015

Related U.S. Application Data
(60) Provisional application No. 62/000,694, filed on May 20, 2014.
(60) Provisional application No. 62/164,060, filed on May 20, 2015.

(51) Int. Cl. G08B 13/24

(52) U.S. Cl. CPC G08B 13/2462

(57) ABSTRACT

A radio frequency identification (RFID) tag design-first, computer-assisted drawn configuration, visualization and monitoring system for monitoring the movement of tagged assets in a given space. The system provides tag information data, and makes all calculations necessary for visually displaying the movements of tags on any imported two dimensional (2D) or three dimensional (3D) floor plan graphic file (e.g., .gif, .png, .jpg or similar formats) in real-time through web-based systems.

This application claims benefit of and priority to U.S. Provisional Application No. 62/000,694, filed May 20, 2014, and U.S. Provisional No. 62/164,060, filed May 20, 2015, by Curtis Lee Shull, and is entitled to those filing dates for priority. The specifications, figures, appendices, and complete disclosures of U.S. Provisional Application Nos. 62/000,694 and 62/164,060 are incorporated herein in their entireties by specific reference for all purposes.

### FIELD OF INVENTION

This invention relates to a system and method for real-time tracking of assets in a space or area, indoors or outdoors. More specifically, this invention relates to a system and method for computer-based design and implementation of a monitoring system for assets in real-time using radio frequency identification (RFID) tags.

### BACKGROUND OF THE INVENTION

Governmental entities, businesses and other owners of assets (such as, but not limited to, files, books, folders, furniture, desks, electronic devices, industrial equipment, and the like) have a need to keep and maintain a proper inventory and tracking system for those assets, particularly critical assets. Tracking of movement of mobile assets helps prevent the loss of those assets, assists in the accurate inventorying of those components, and prevents delays in missions or activities where those assets are needed.

Current asset tracking systems known in the art provide limited solutions, but generally are limited to tracking devices offered by specific hardware vendors, which constrain project performance and represent a risk based on changes in business models or strategic business goals that have requirements outside the specific paradigm of a particular system. Such systems also do not provide the flexibility to provide real-time tracking and display of assets being moved around dynamic real estate (indoors or outdoors).

Accordingly, what is needed is an asset tracking system with flexibility in the design and definition of protected or tracked areas, and able to provide real-time graphic tracking of tracked assets.

### SUMMARY OF THE INVENTION

In various exemplary embodiments, the present invention comprises a radio frequency identification (RFID) tag design-first, computer-assisted drawn configuration, visualization and monitoring system for monitoring the movement of tagged assets in a given space. The system provides tag information data, and makes all calculations necessary for visually displaying the movements of tags on any two dimensional (2D) or three dimensional (3D) imported floor plan graphic file (e.g., .gif, .png, .jpg or similar formats) in real-time through web-based systems.

In particular, the system allows any end-user to import any valid graphic floor plan file and draw computer assisted zone overlays that allow the assignment of an RFID antenna that creates an associative reference enabling real-time asset tracking on a web-based distributed system or website (i.e., real-time in the context of a distributed system). The system associates specific RFID reader events, objects and tag streams with corresponding floor plan zones. The system also autonomously interpolates the tag associations from graphic computer-assisted generated zones to display and store each movement (e.g., a tag moved from “Office 1” to “Office 2” at “Date/Time” and was last seen at “Date/Time”) in a database. The system further provides visual trend analysis and historical information about all movements that are drawn graphically on the floor plan element.

The system provides a user-friendly interface allowing a user (e.g., asset manager) to efficiently create a tracking and monitoring area by drawing zones using the computer floor plan graphic file, and configuring the zones quickly for business models and strategic goals for tracking and monitoring assets. The system then immediately provides autonomous real-time visual information of asset movements. The user can ascertain asset movement and location quickly through visual displays that augment any grid reporting of tag/asset movement and data, thereby providing an animated, RFID-tag tracking system providing a visual bird-eye animated view of current movements of assets, first/last seen dates of assets, and a powerful image-based movement/path event-based scheme from a computer-assisted graphical drawing and design functionality.

In several embodiments, the present invention comprises a web-based distributed application system, which may operate through one or more computer or service devices. The system imports graphic files (e.g. floor plans), and provides computer-assisted drawing of overlays and adding of objects and text. The design configuration is then saved in an appropriate file format (e.g., XML). The association of the RFID-reader object, events and streams with the computer-assisted importing and drawing of the RFID-reader object on floor plans allows the graphical display of the tracked asset to occur very quickly. The graphical display may include, but is not limited to, information about antennae, zones, monitoring zones, objects, containers of objects, center points of objects, or polygonal points of objects and zones.

The present invention can incorporate any RFID reader (or similar device, regardless of frequency or specification. The tracking software can run on any computing device, including, but not limited to, portable computing devices, tablets, mobile computing device, PDAs, cell phones, and the line. RFID readers may be connected by LAN, WAN, or by directed wired connection to the computing device.

In one embodiment, the present invention comprises at least one RFID reader, such as a long range 900 Mhz Radio Frequency RFID Reader, and a plurality of polarized antennae. The RFID readers are connected wireless or by wired connections (e.g., TCIP, serial port, or the like). The computing device is a desktop-based computer, with software loaded thereon for importing graphical floor plans and files to provide a visual representation that corresponds to an entire tracking area responsibility. The invention provides the end-user the ability to create digital illustration of overlays, circle squares, color fill or images superimposed over any portion of an imported floor plan under the direct manipulation of a tablet or a mouse, and computer-aided design with precise shape-building tools. The invention provides graphical icon toolset call containers that will act as either trigger mechanisms for the RFID reader or storage of associated tag lists. Containers are objects that either creates a trigger that starts the RFID reader event or storage of associated RFID tag lists. When a tool icon from the toolset is dragged onto the imported floor plan image, an associated dialogue appears to capture important information about the tool. If an antenna or reader tool icon is dragged on to the floor plan image, then a dialog will appear with a scaled down floor plan image and any zone overlays that have been drawn on the image. Any antenna can be assigned to any drawn zone creating the zone/antenna relationship. In one embodiment, the invention comprises a desktop application that utilizes Microsoft's SignalR framework to send messages, alerts and signals to the web server in real-time.

Accordingly, in several embodiments, the present invention (b 1) provides a desktop application connected to one or more RFID reader devices, (2) provides a list of available antennas autonomously, (3) provides an import of floor plan images and the ability to superimpose/draw overlays over imported images, (4) provides for the assignment of available RFID antennas to previously drawn zones/overlays; (5) sends the saved image and data to an XML file (which may be sent via TCIP or HTTP to an IIS web server as XML file, where web server redraws the image from the XML), (6) provides real time updates, through a web-based software system, of tag movement through autonomous creation and drawings of lines and squares; (7) allows the user to click on any real-time object revealing the exact asset that moved and the time it moved; (8) provide grid views that allow any row of grid data, once selected, to depict the visual path representing movement of the tagged asset between zones.

### BRIEF DESCRIPTION OF THE DRAWINGS

FIG. 1 shows a view of a system in accordance with an embodiment of the present invention.

FIG. 2 shows an exemplary user login and connection configuration screen.

FIG. 3 shows an exemplary connection screen.

FIG. 4 shows an exemplary file dialog window.

FIG. 5 shows an exemplary graphical area map import screen.

FIG. 6 shows a representative tool set.

FIGS. 7A-B show an example of the square selection tool.

FIG. 8 shows an exemplary zone dialog box.

FIG. 9 shows an exemplary RFID device assignment information dialog box.

FIG. 10 shows an exemplary zone assignment dialog box.

FIGS. 11-15 show examples examples of the zone selection process.

FIGS. 16A-17B show examples of the antenna assignment process.

FIG. 18 shows an exemplary save tracking area template box.

FIGS. 19-21 show examples of tag programming and zone assignment screens.

FIGS. 22-29 show examples of real-time monitoring and tracking screens.

FIGS. 30-36 show examples of tag history and trend analysis screens.

FIGS. 37-38 shows diagrams of the methodology of the present invention.

### DETAILED DESCRIPTION OF EXEMPLARY EMBODIMENTS

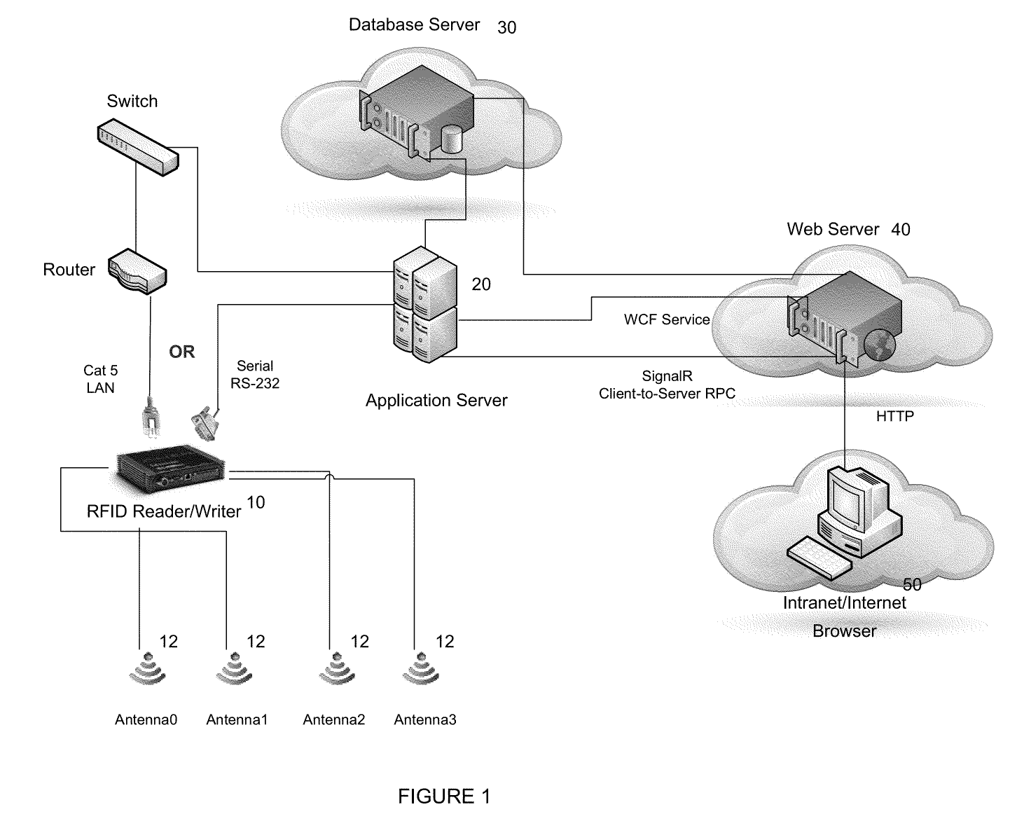

In various exemplary embodiments, the present invention comprises a radio frequency identification (RFID) tag design-first, computer-assisted drawn configuration, visualization and monitoring system for monitoring the movement of tagged assets in a given space. The system provides tag information data, and makes all calculations necessary for visually displaying the movements of tags on any two dimensional (2D) or three dimensional (3D) imported floor plan graphic file (e.g., .gif, .png, .jpg or similar formats) in real-time through web-based systems, as shown in FIG. 1. As seen in FIG. 1, one embodiment of the system comprises an RFID reader/writer 10 in electronic communications with a plurality of RFID antennas 12, and with an application server 20 (through a serial port connection, a CAT 5 LAN connection, or similar connection), which in turn is in electronic communication with a database server 30 and a web server 40. A user, through a browser or application 50 on a personal computer or other computing device, accesses the system through the web server.

In particular, the system allows any end-user to import any valid graphic floor plan file and draw computer assisted zone overlays that allow the assignment of an RFID antenna (or a plurality of antennas) that creates an associative reference enabling real-time asset tracking on a web-based distributed system or website (i.e., real-time in the context of a distributed system). The system associates specific RFID reader events, objects and tag streams with corresponding floor plan zones. The system also autonomously interpolates the tag associations from graphic computer-assisted generated zones to display and store each movement (e.g., a tag moved from “Office 1” to “Office 2” at “Date/Time” and was last seen at “Date/Time”) in a database. The system further provides visual trend analysis and historical information about all movements that are drawn graphically on the floor plan element.

The system provides a user-friendly interface allowing a user (e.g., asset manager) to efficiently create a tracking and monitoring area by drawing zones using the computer floor plan graphic file, and configuring the zones quickly for business models and strategic goals for tracking and monitoring assets. The system then immediately provides autonomous real-time visual information of asset movements. The user can ascertain asset movement and location quickly through visual displays that augment any grid reporting of tag/asset movement and data, thereby providing an animated, RFID-tag tracking system providing a visual bird-eye animated view of current movements of assets, first/last seen dates of assets, and a powerful image-based movement/path event-based scheme from a computer-assisted graphical drawing and design functionality.

In several embodiments, the present invention comprises a web-based distributed application system, which may operate through one or more computer or service devices. the system imports graphic files (e.g. floor plans), and provides computer-assisted drawing of overlays and adding of objects and text. The design configuration is then saved in an appropriate file format (e.g., XML). The association of the RFID-reader object, events and streams with the computer-assisted importing and drawing of the RFID-reader object on floor plans allows the graphical display of the tracked asset to occur very quickly. The graphical display may include, but is not limited to, information about antennae, zones, monitoring zones, objects, containers of objects, center points of objects, or polygonal points of objects and zones.

The present invention can incorporate any RFID reader (or similar device, regardless of frequency or specification. The tracking software can run on any computing device, including, but not limited to, portable computing devices, tablets, mobile computing device, PDAs, cell phones, and the line. RFID readers may be connected by LAN, WAN, or by directed wired connection to the computing device.

In one exemplary embodiment, the present invention comprises at least one RFID reader, such as a long range 900 Mhz Radio Frequency RFID Reader, and a plurality of polarized antennae. The RFID readers are connected wireless or by wired connections (e.g., TCIP, serial port, or the like). The computing device is a desktop-based computer, with software loaded thereon for importing graphical floor plans and files to provide a visual representation that corresponds to an entire tracking area responsibility. The invention provides the end-user the ability to create digital illustration of overlays, circle squares, color fill or images superimposed over any portion of an imported floor plan under the direct manipulation of a tablet or a mouse, and computer-aided design with precise shape-building tools. The invention provides graphical icon toolset call containers that will act as either trigger mechanisms for the RFID reader or storage of associated tag lists. Containers are objects that either creates a trigger that starts the RFID reader event or storage of associated RFID tag lists. When a tool icon from the toolset is dragged onto the imported floor plan image, an associated dialogue appears to capture important information about the tool. If an antenna or reader tool icon is dragged on to the floor plan image, then a dialog will appear with a scaled down floor plan image and any zone overlays that have been drawn on the image. Any antenna can be assigned to any drawn zone creating the zone/antenna relationship. In one embodiment, the invention comprises a desktop application that utilizes Microsoft's SignalR framework to send messages, alerts and signals to the web server in real-time.

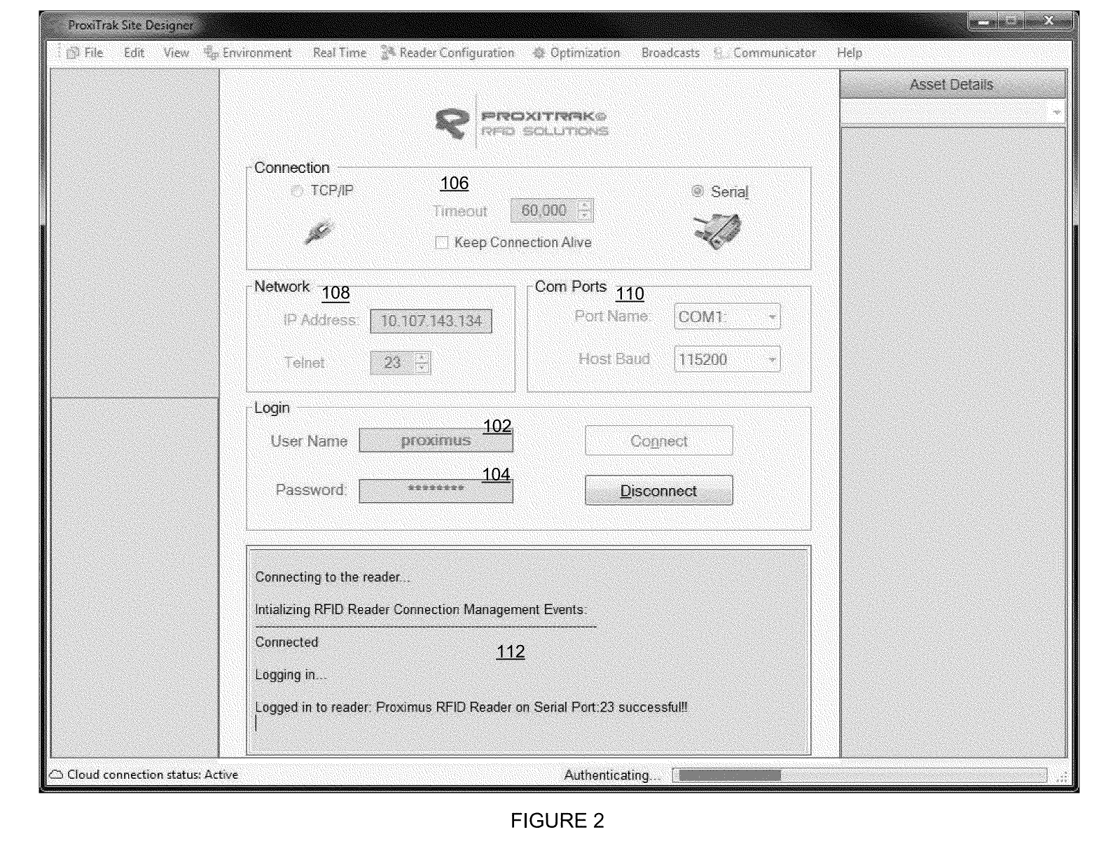

FIGS. 2-19 show various examples of user interface screens for an embodiment of an application of the present invention. FIG. 2 shows an example of a user login and connection configuration interface screen. The user can login with a user name 102 and password 104, although alternative means of secure access (e.g., biometrics) may be used. From this screen the user can also specify connection type 106, network information 108, and com port information 110. A status window 112 can provide messages or details about event and connection status.

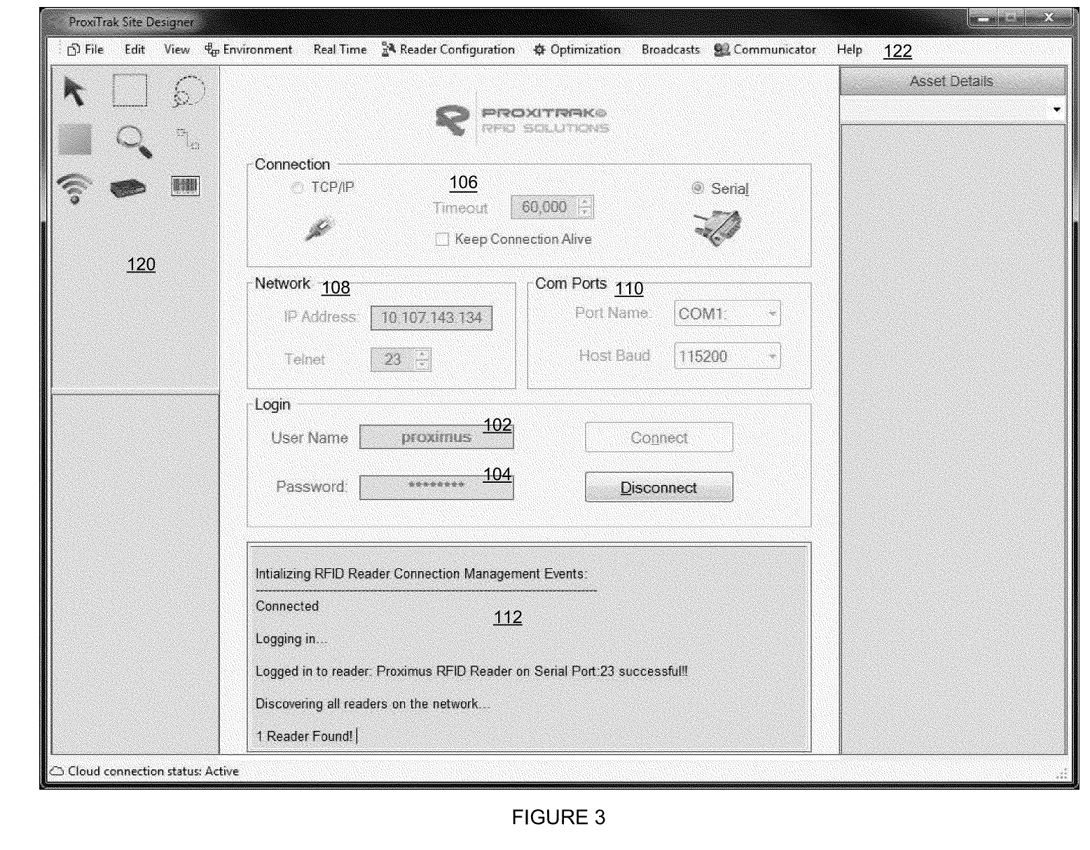

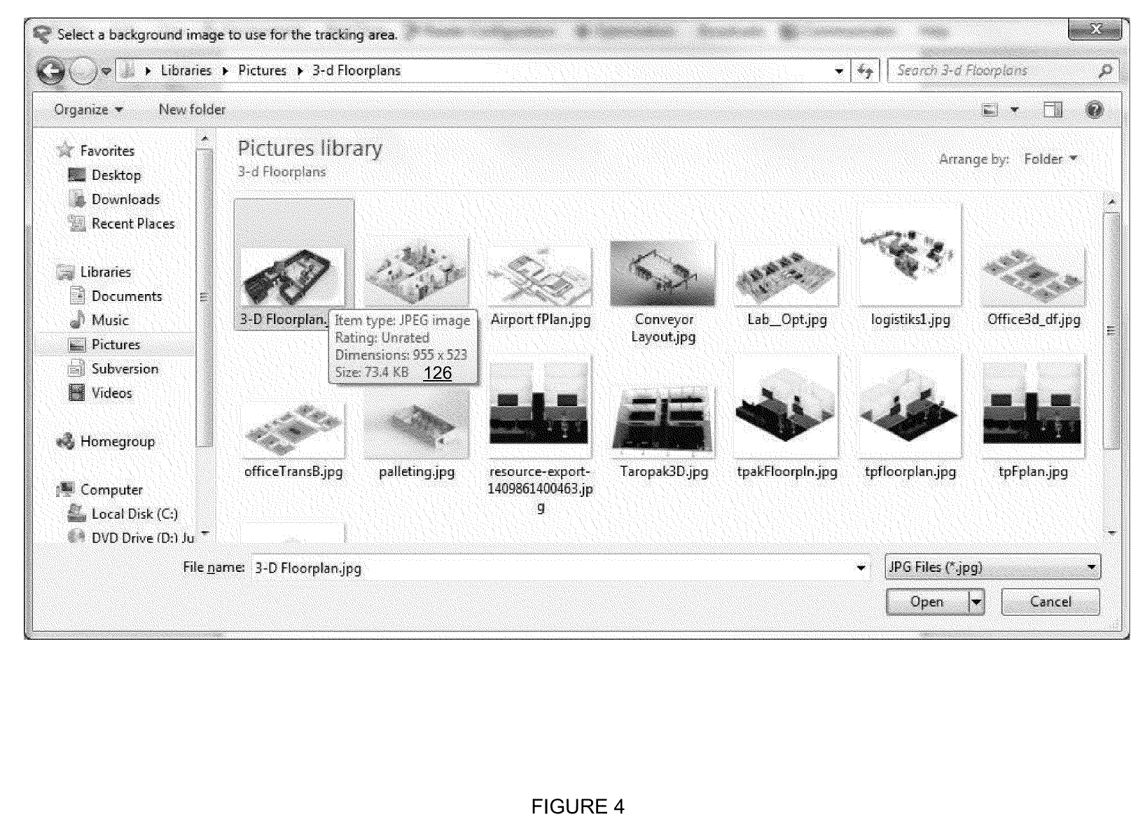

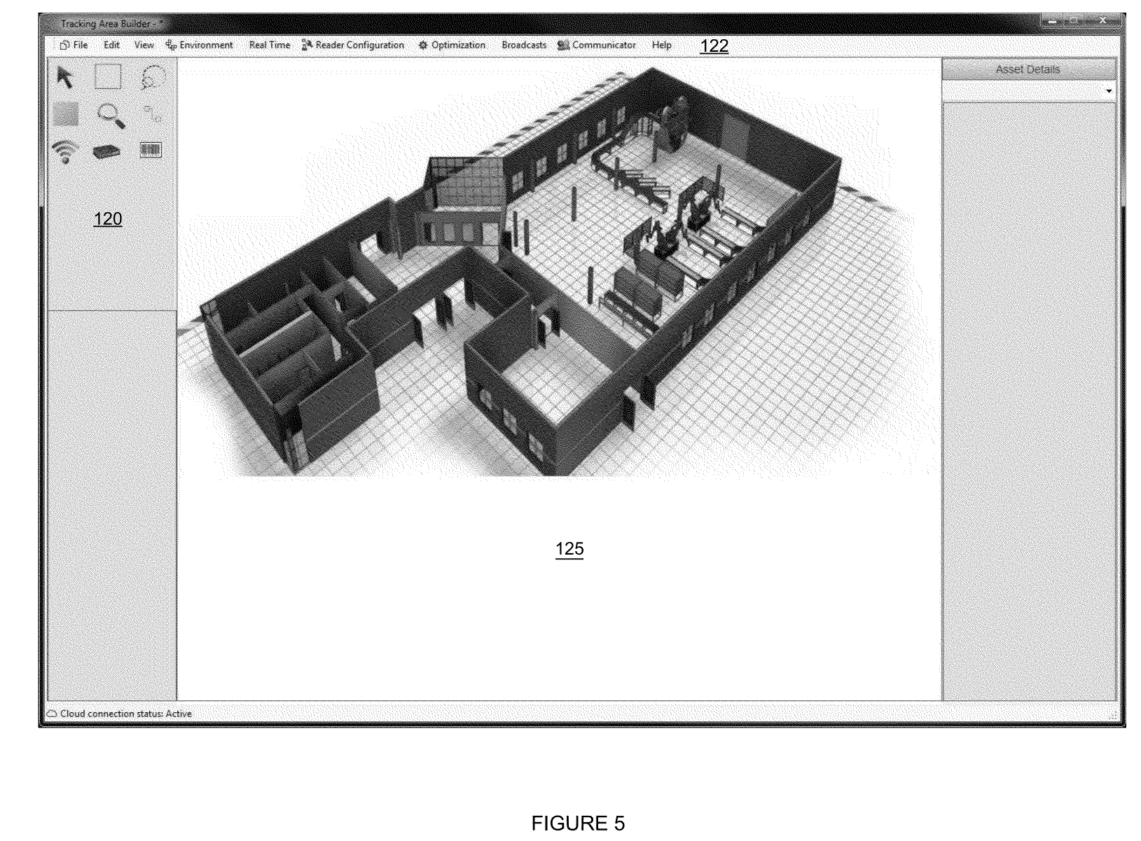

Once connected, the user is presented a connection screen as seen in FIG. 3. This is similar to FIG. 2, with the addition of a number of tool icons 120, as well as an active menu bar 122. From here, the user can identify and load a new tracking area by creating a new file using the new file option in the menu. This opens the file dialog window shown in FIG. 4. This allows the user to specify an image file, either directly or by browsing and selecting a file in a folder or library. Clicking on an image provides information about the file. Opening the selected file causes the graphical floor plan image 125 to open in the graphical area map import screen, as seen in FIG. 5.

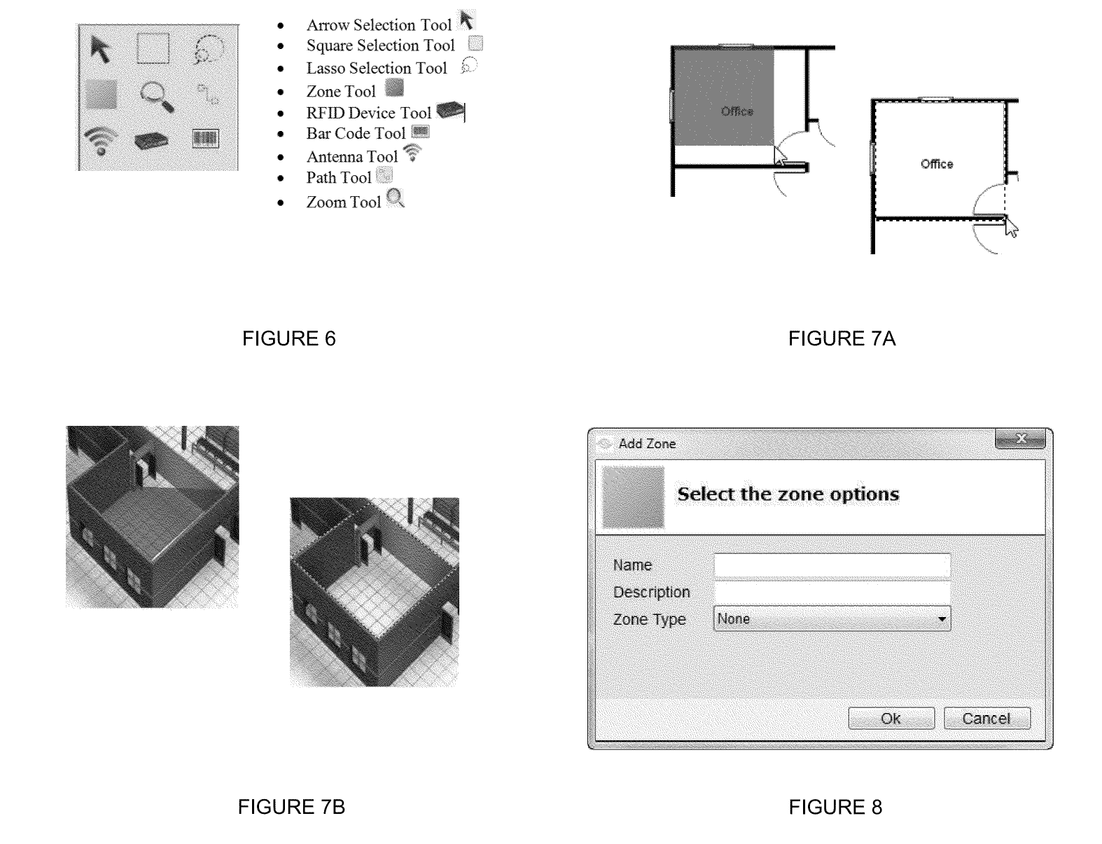

In the graphical area map import screen, the tool set 120 located on the left panel contains multiple graphical icons that represent drawing tools. The drawing tools can be selected and dragged onto the background image to represent different objects that interact programmatically with the RFID reader/writer. FIG. 6 shows a representative tool set with index.

When the arrow tool is selected from the toolset panel the mouse cursor is represented by the arrow icon. The arrow tool is used for selecting any component, control, panel, window or dialog.

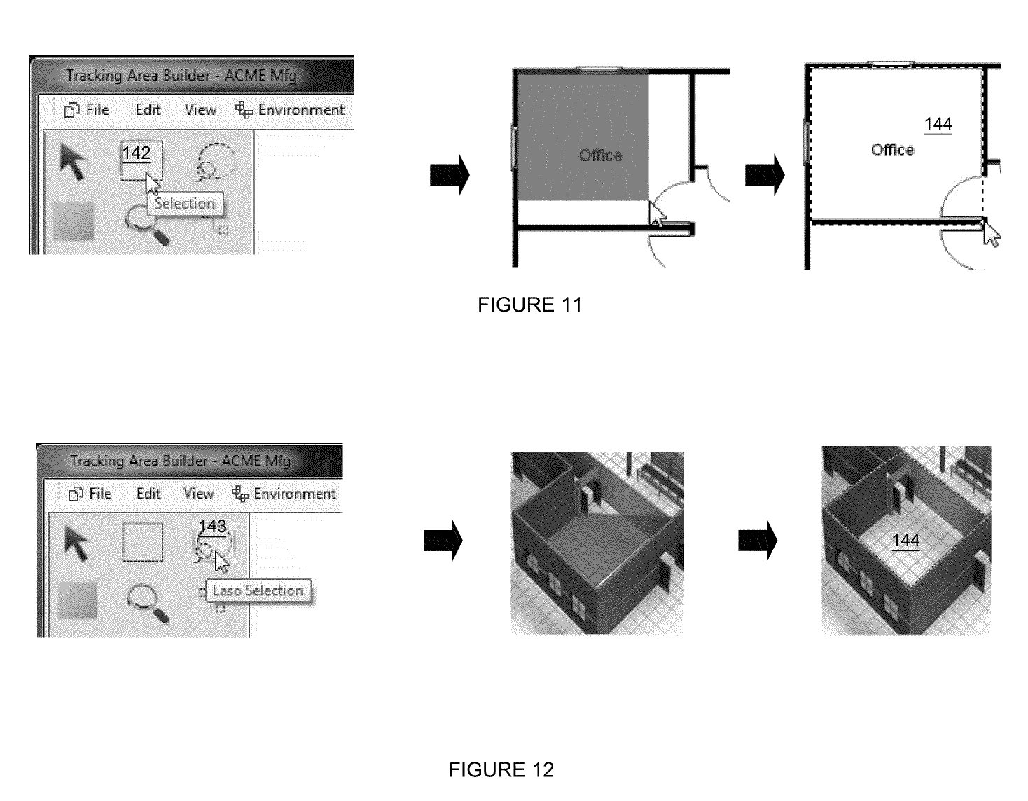

When the square selection tool 142 is selected it sets the functionality of the mouse cursor to draw square overlays over the graphical image in the primary panel. While dragging the square selection tool over the graphical image the square will be purple in color until the drag motion is complete and which point the square overlay will be transparent except for a dotted-line border 144 representing the square selection. This tool is a precursor for the zone tool and must be used prior to using the zone tool. An example of the square selection tool being used (for both 2-D and 3-D graphical images) is seen in FIG. 11.

When the lasso selection tool 143 is selected it sets the functionality of the mouse cursor to draw polygon overlays over the graphical image in the primary panel. While dragging the lasso selection tool over the graphical image, the polygon angles will be purple in color until the drag motion is complete and which point the lasso overlay image will be transparent except for a dotted line border 144 representing the square that was just drawn This is useful when the user has unconventional tracking areas that are not quadrilateral. This tool is a precursor for the zone tool and must be used prior to using the zone tool. An example of the lasso selection tool being used is seen in FIGS. 7A-B and 12.

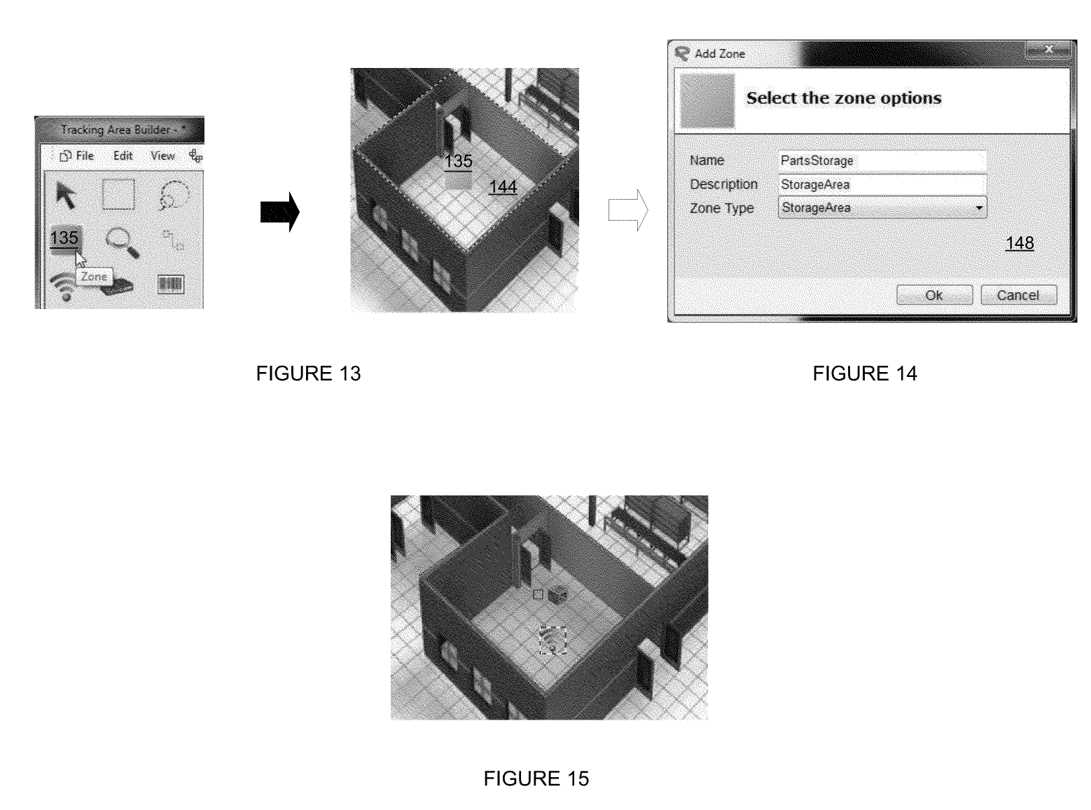

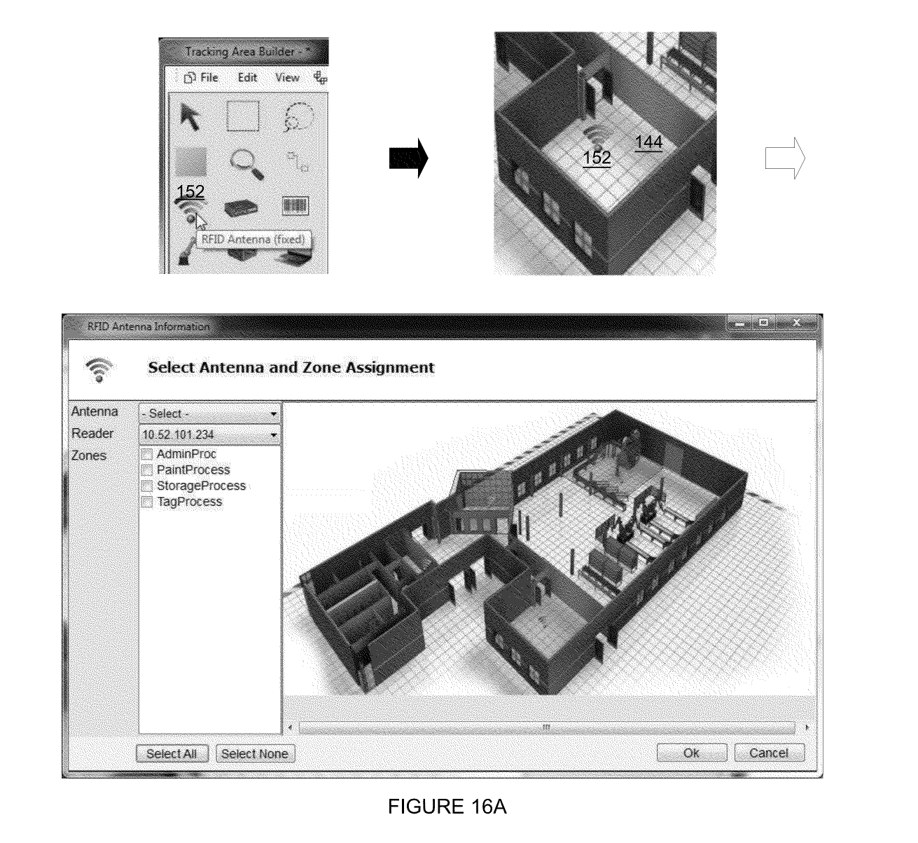

The zone tool 135 represents a drawn area called a zone and simply fills the area drawn by the square selection tool or the lasso selection tool. When selecting the zone tool, the mouse cursor will change to represent the blue zone icon which was selected. This tool is then dragged with the mouse anywhere inside a previously drawn square or lasso area 144. Once within the pre-drawn areas, the user can click the left mouse button and the system fills the pre-drawn area with a blue opaque color, as seen in FIG. 15. Once the zone tool has been clicked onto the graphical image, it will open a file dialog that requires basic information about the zone just created or indicated, as seen in FIGS. 8 and 13.

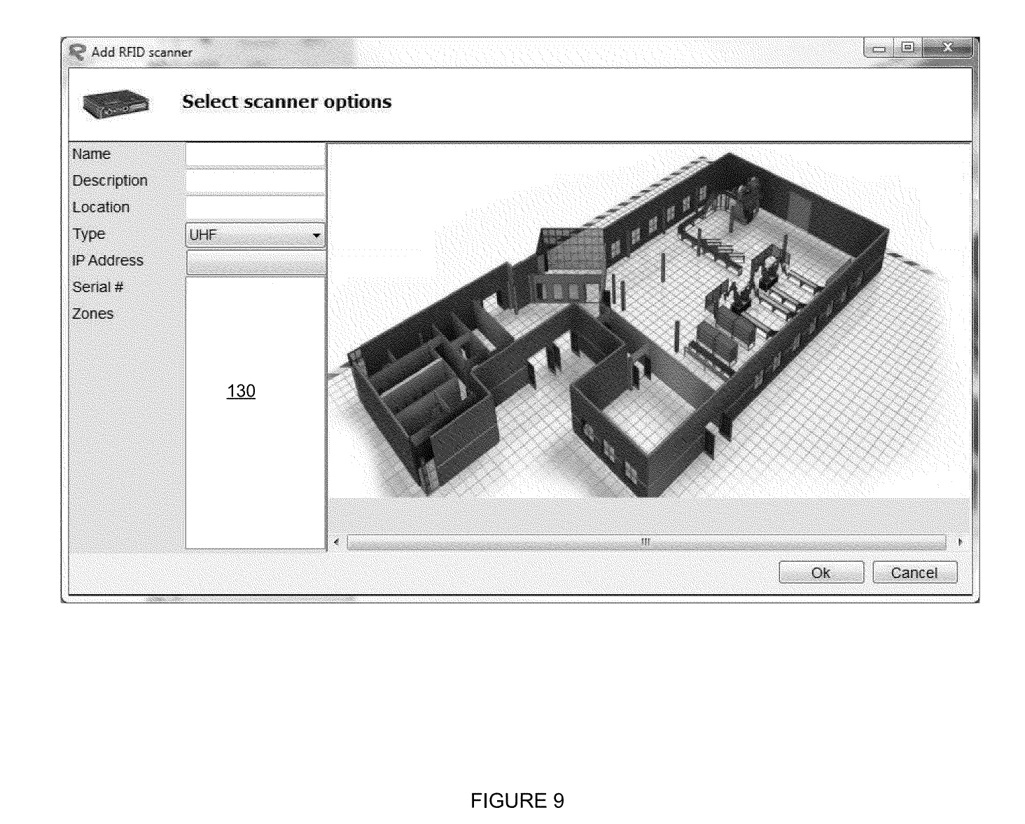

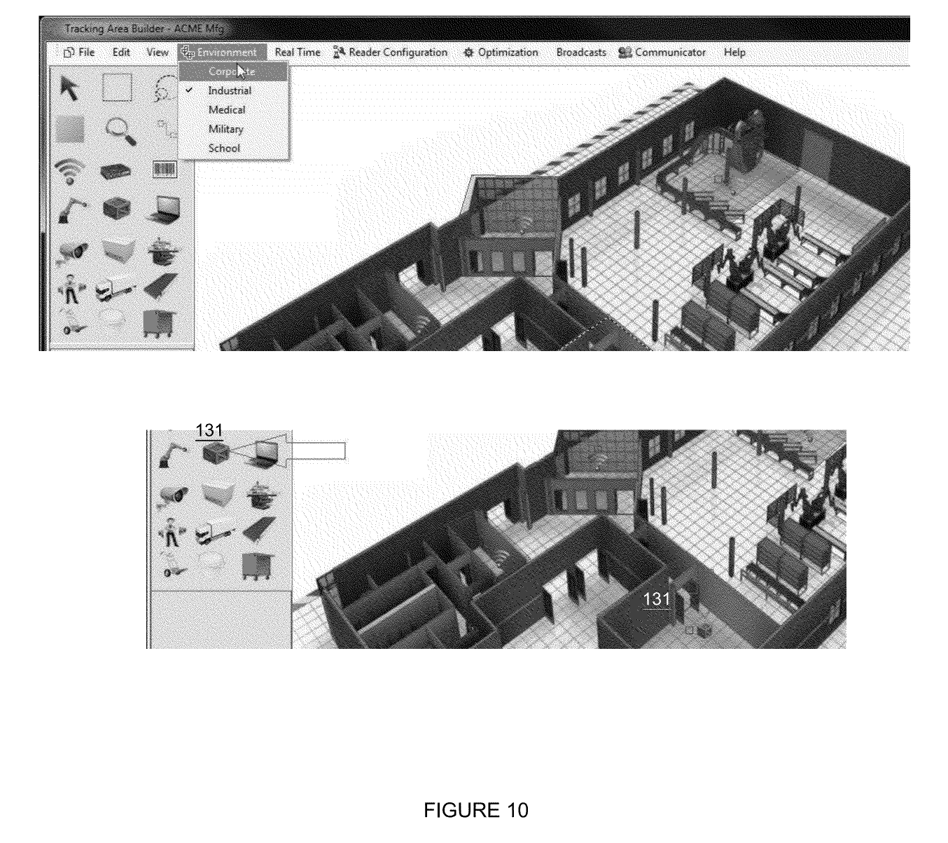

The RFID device tool is used to draw a representation of an RFID device to be displayed in the tracking area. This tool is useful if the user wants a visual representation of the RFID device. When selecting the RFID device tool, the mouse cursor will change to represent the RFID device icon which was selected. Once the RFID device tool has been clicked onto the graphical image, it will open a file dialog that requires basic RFID device assignment information 130, as seen in FIG. 9. The Environment option from the top menu strip contains many additional “container” tools that allow the user to draw a physical object on the graphical image and assign a “container” 131 to hold and track tags, as seen in FIG. 10. The antenna tool 152 is used to draw a representation of an antenna tool to be displayed in the tracking area, This tool is the most important tool for real time tracking and location as it can be assigned to any pre-drawn zone 144. When selecting the antenna tool, the mouse cursor will change to represent the antenna icon which was selected. Once the antenna tool has been clicked onto the graphical image, it will open a file dialog that requires zone assignment, as seen in FIGS. 11 and 14.

The zoom tool allows the user to zoom in/out on the graphical image in the main window. After selecting the tool and placing the mouse cursor on the graphic image, left/right clicking the mouse zooms the image in/out respectively.

From the tool icon panel, the user selects the square or lasso tool. FIG. 11 shows an example a square tool selection, FIG. 12 shows a Lasso tool selection. Both can be used to indicate the desired tracking area (by dragging the square indicator to cover the “office” area, or “3d room” in respective examples). The user then selects the zone tool, and clicks the left mouse button when the tool cursor is located inside the dotted line drawn by the lasso tool, as seen in FIG. 12. The user then enters zone information in the zone dialog box (as seen in FIG. 14). FIG. 15 shows an example of a floorplan where multiple three dimensional rooms have been indicated as zones.

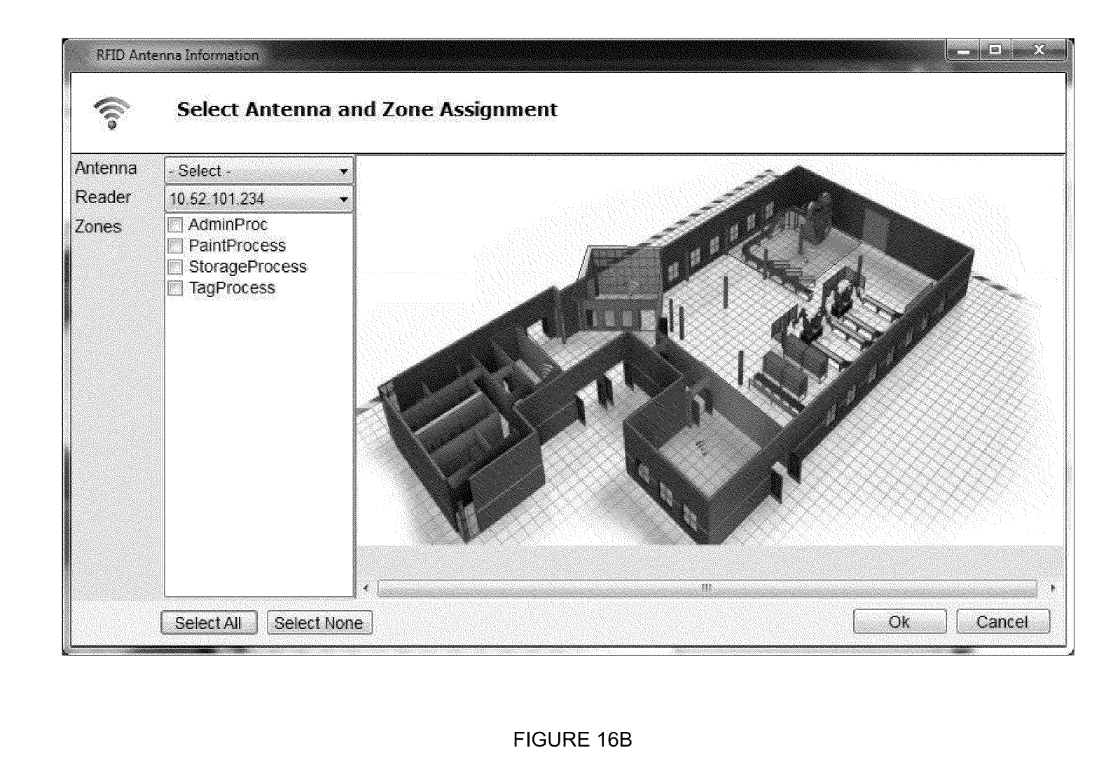

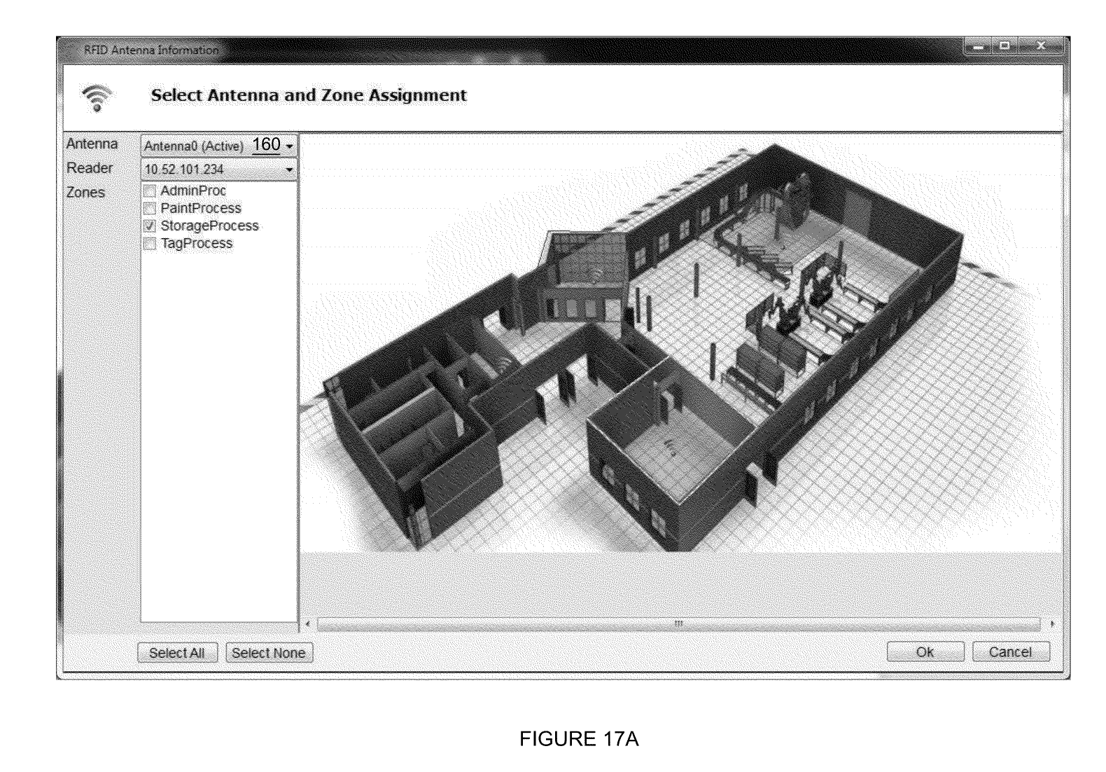

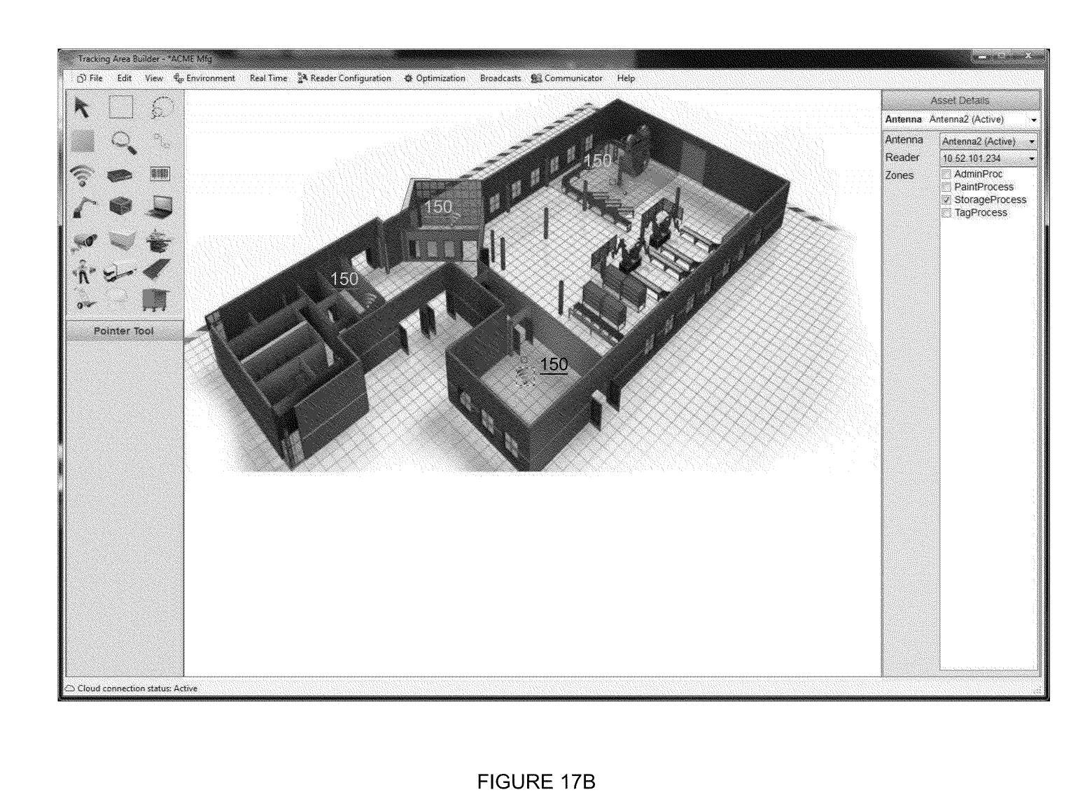

The user can then choose the antenna tool, move the tool to the desired zone, and click to set the antenna in place, as indicated in FIGS. 16A, B. The user then enters antenna information in the antenna dialog box (similar to the zone dialog box). FIGS. 17A, B show an example of a floorplan where antennas 150 have been placed in the indicated zones. The user here can select individual antennas from the antenna list 160.

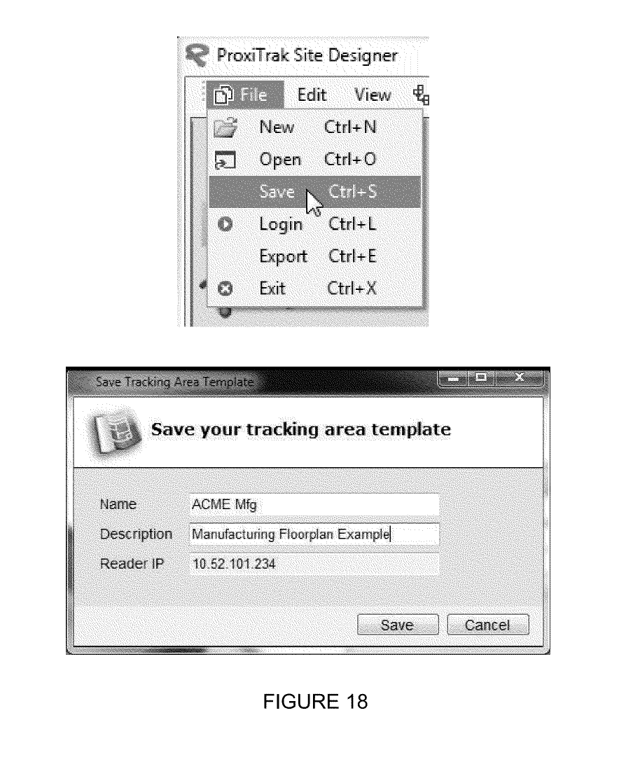

After the tracking area design is complete, the user then saves the tracking area template file. An example of a save tracking area template box 170 is shown in FIG. 18.

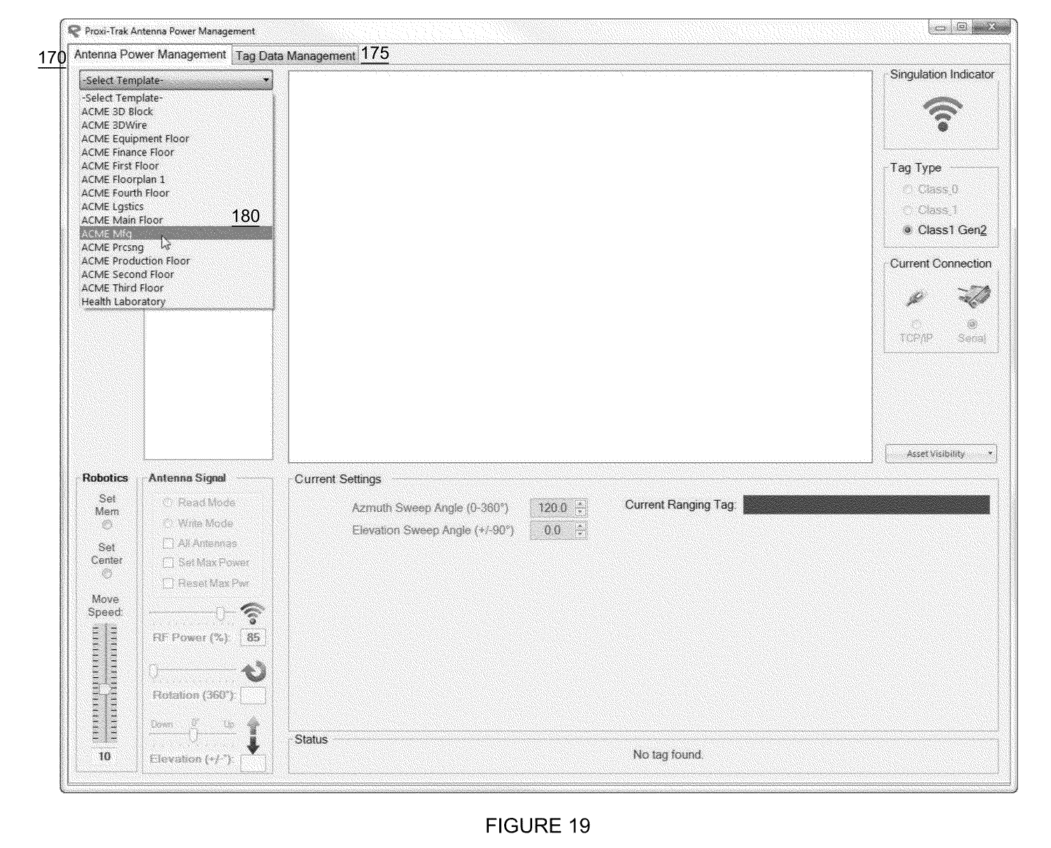

FIG. 19 shows an example of a Optimization screen with tabs Antenna Power Management 170 and Tag Data Management 175. The Antenna Power Management tab is simply an interface that allows the user to display the pre-designed graphical representation and analyze distance measuring through manipulation of RSSI (reader signal strength indicator) and (optional robotics) elevation, rotation and sweep angle alignment functionality to maximize efficiency of the tracking environment.

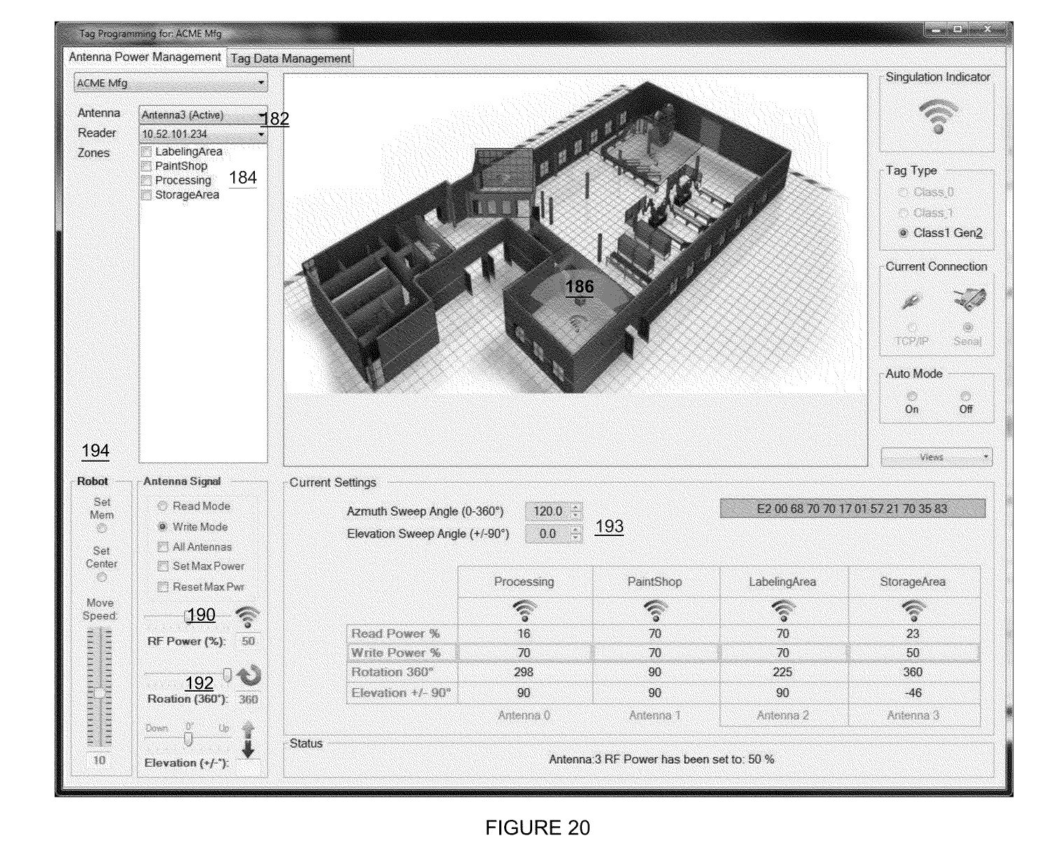

The user selects a floor plan 180 from available tracking area graphic files (designed and saved as described above). This results in the screen shown in FIG. 20. Selecting an antenna from the dropdown list 182 or checking a zone check box 184 will render a yellow, red and blue RF field strength animation 186 that animates, grows and positions according to the RF power slide 190 settings and antenna rotation 192 settings.

Every time these two settings are manipulated, a new RF field strength will be drawn (animated) automatically. The RF field strength displays different colors denoting the following: Red—the tag is at the maximum/minimum writing distance (could damage tag at minimums); Yellow—caution range max/min; Blue—optimum range. The application allows the user to select RF power (percentage) 190 to adjust programming antenna strength, rotation to rotate the antenna 192 as it is physically oriented in the actual tracking environment, as well as configure remote robotic 194 controlled antenna parameters.

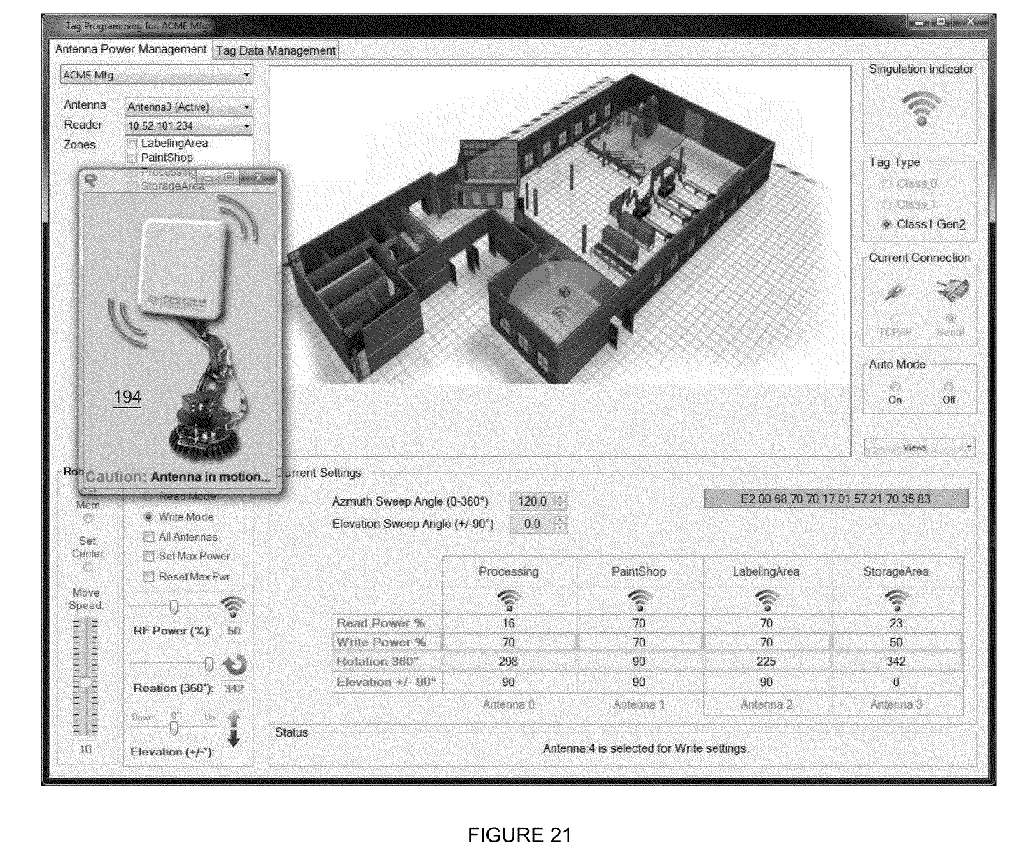

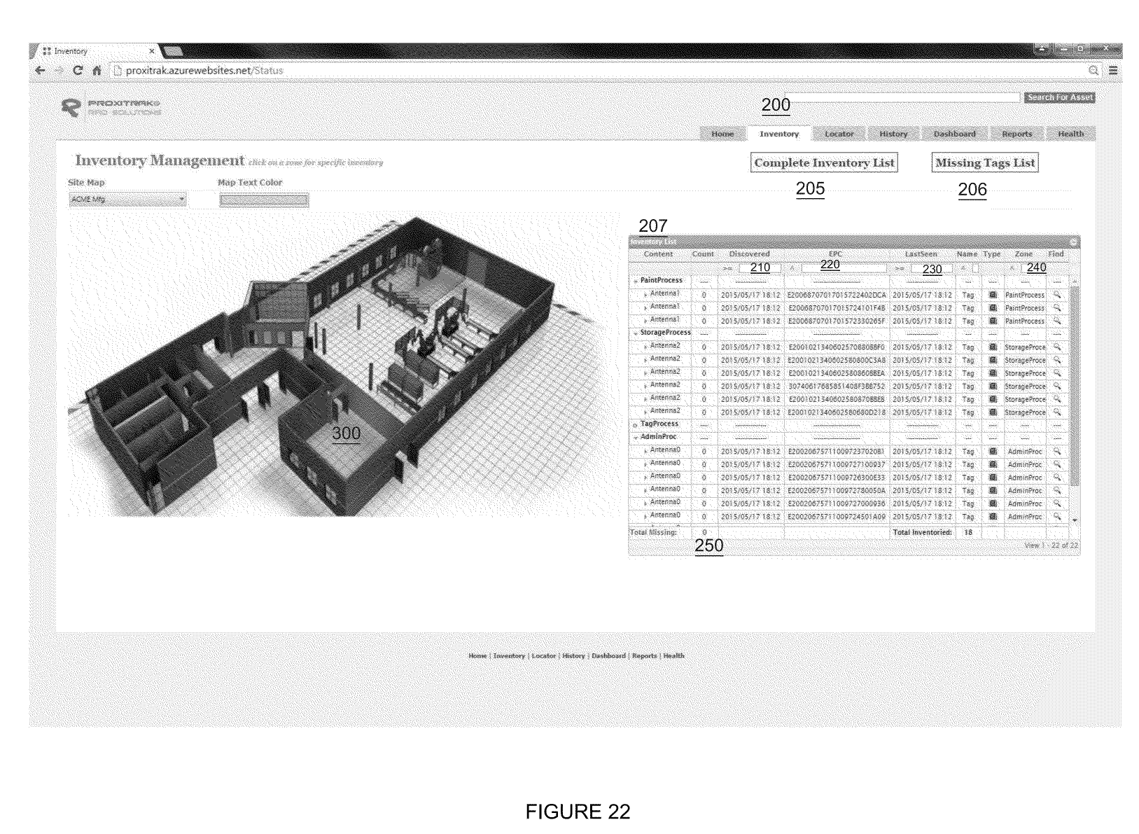

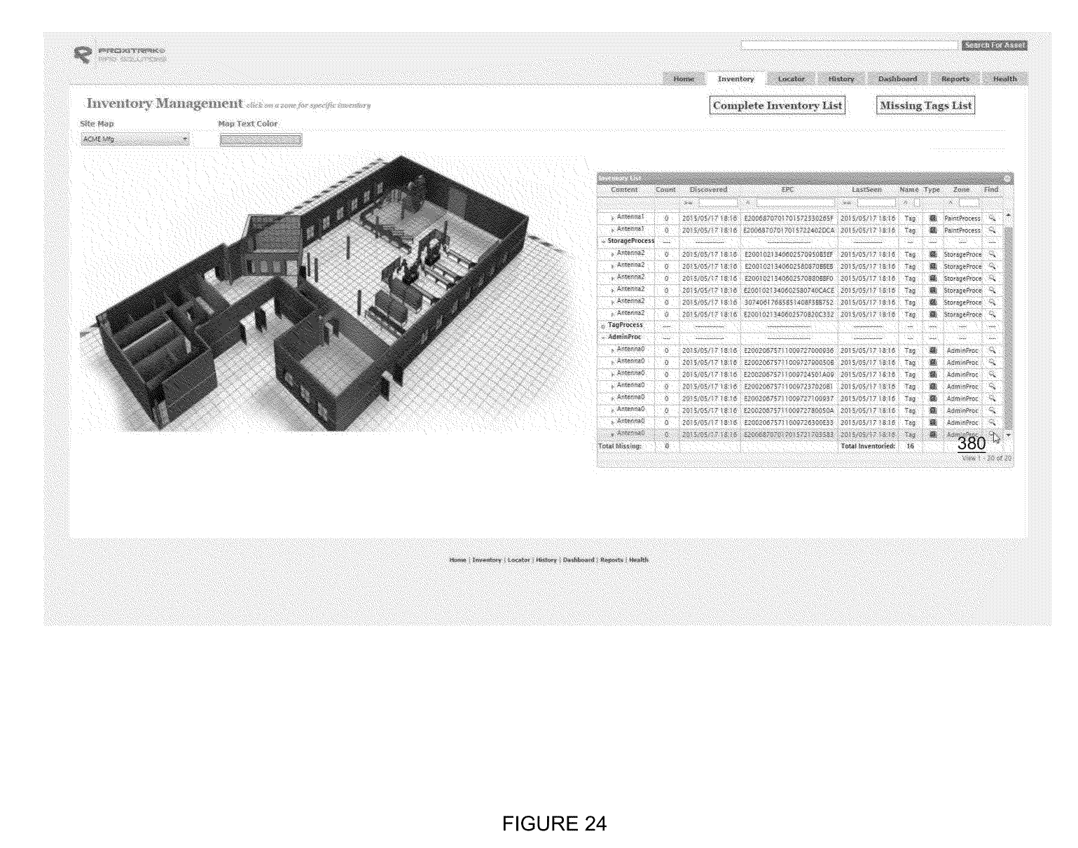

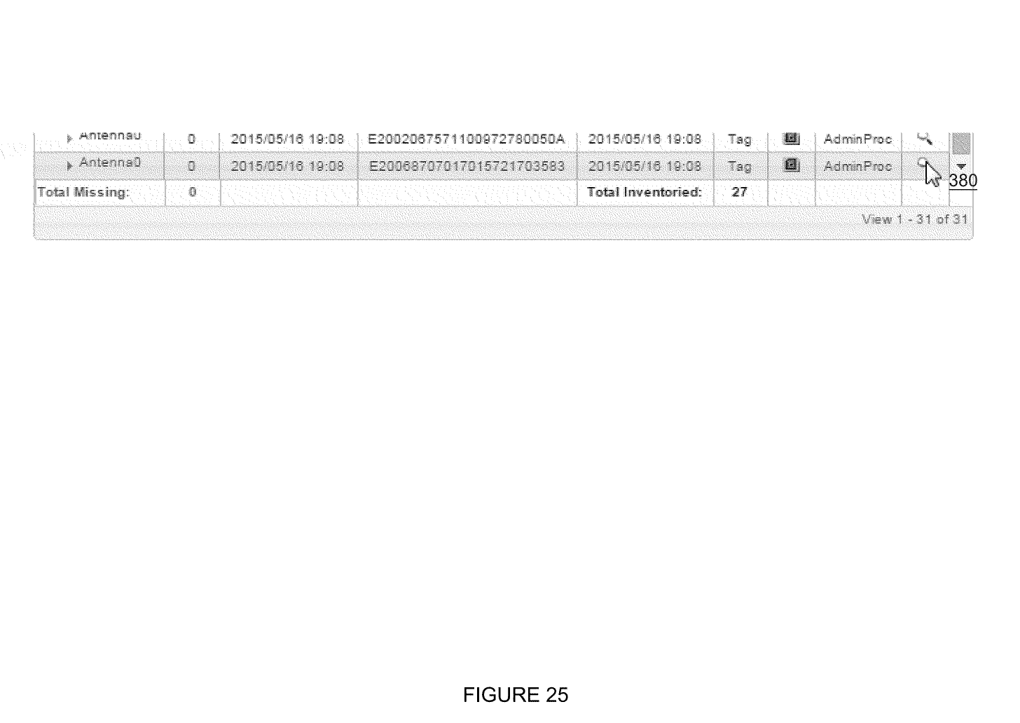

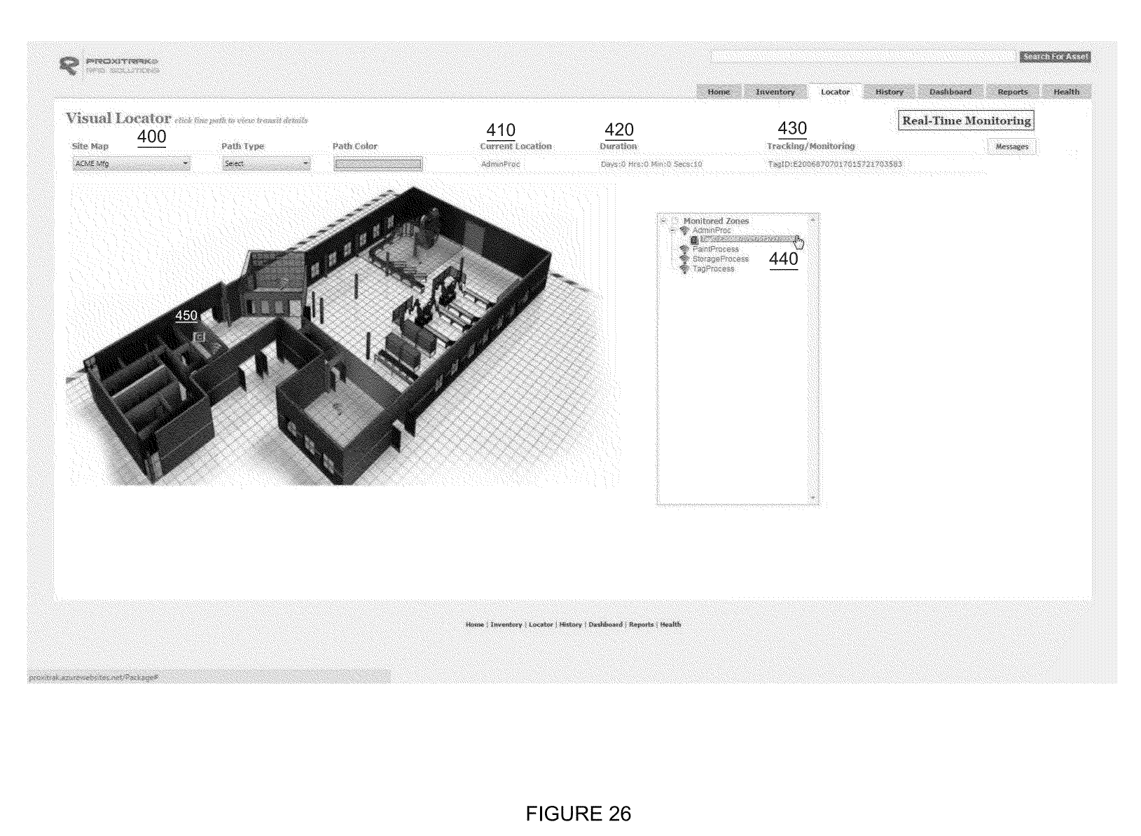

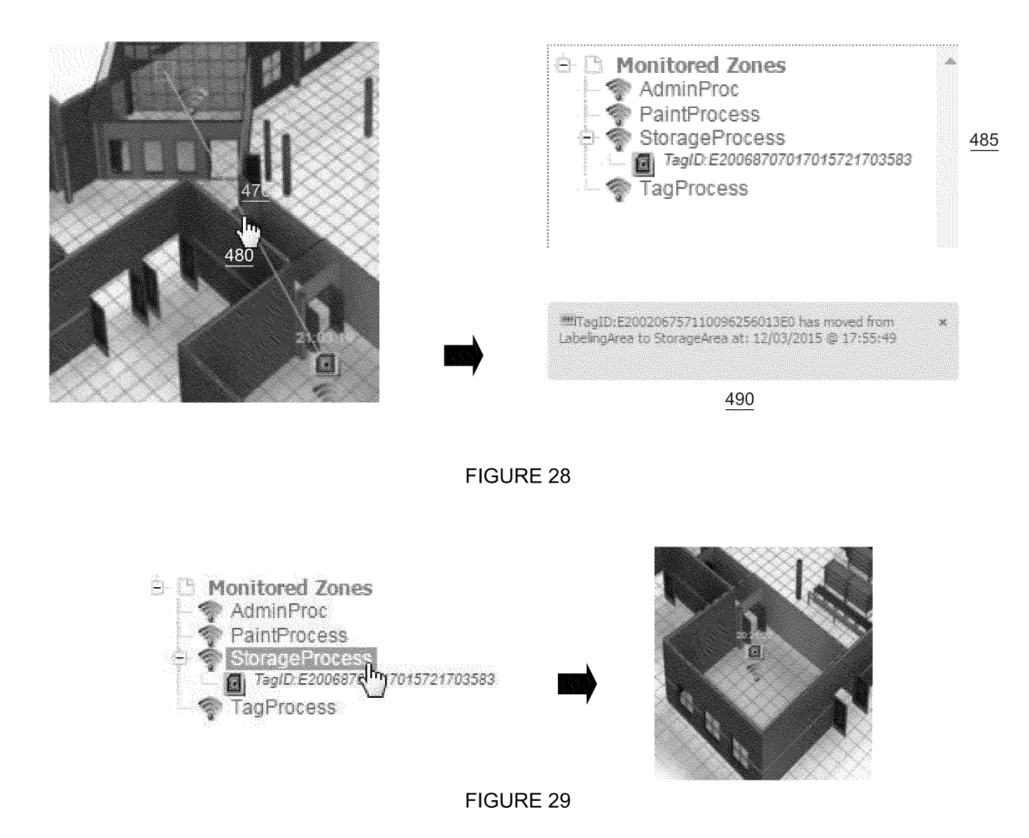

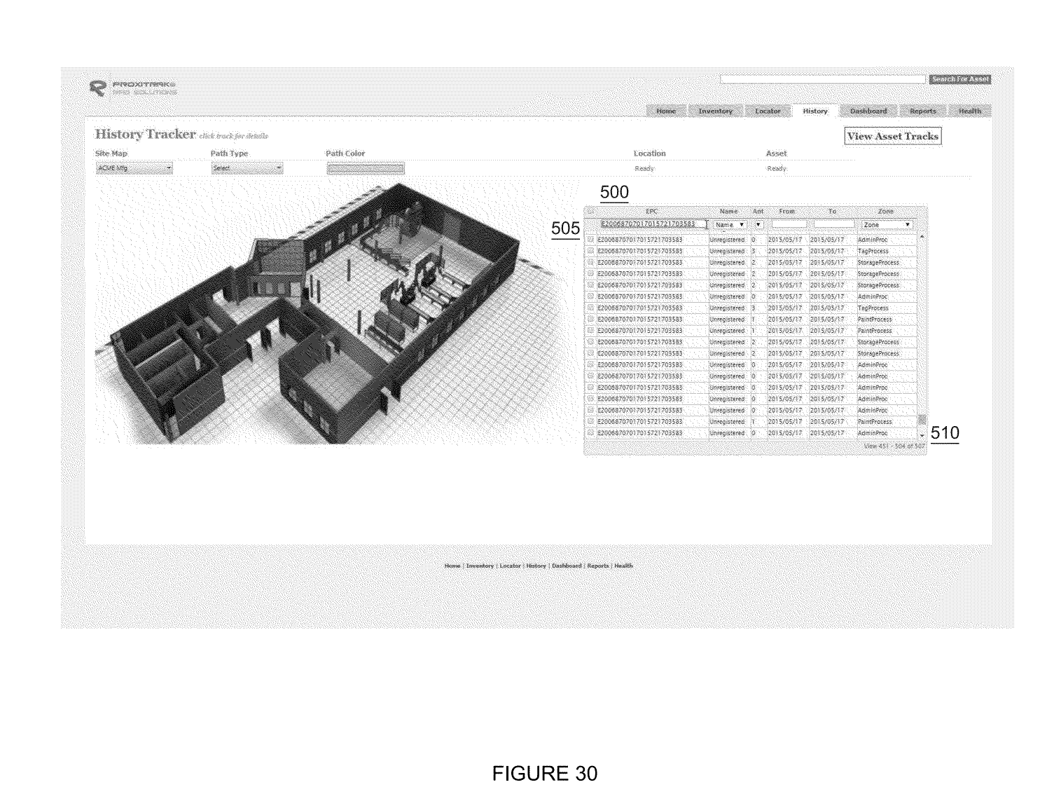

Once the tracking area design is completed, once saved, the tracking area solution is immediately available in the web server and distributed environment, and can provide instance location metrics, surveillance and monitoring in real time. Examples of real-time monitoring and tracking screens showing the movement of a tracked asset (e.g., a pallet of boxes) are seen in FIGS. 19-32.

The inventory page on the web-based system consist of a data grid 207 which is pushed data in real-time from RFID antenna interrogations. The user selects inventory from the web based system which is now the Live Site Survey graphical representation of your RFID infrastructure.

The user can search using the date/time filter which indicates when the tag was first discovered 210 by the reader. The user can enter tag data in the main search input box 200 which will perform a search across the real-time inventory and display the results in the respective graphical zone.

The user can elect and click the “Missing Tag List” button 206 to invoke a real-time inventory event on the entire site and the grid data that locates missing tags from your site's inventory. Missing tags will be highlighted in red with a total count 250 of missing tags indicated at the bottom of the grid data.

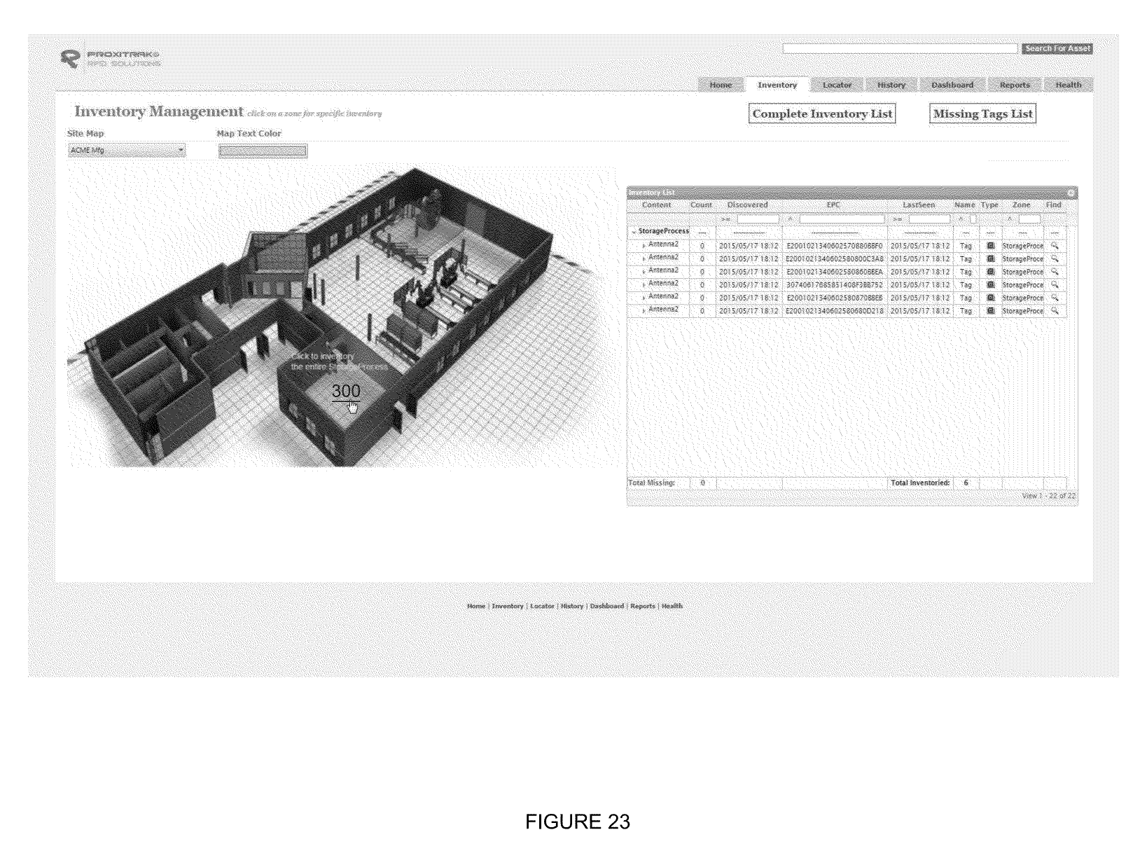

The inventory page is fully interactive and user searchable 200. When the user moves the cursor over a graphical zone “Click to Inventory” 300 will be displayed over that zone allowing you to invoke a real-time inventory specifically for that zone as indicated in FIG. 23. When the user clicks a zone 300 two-way communication is imitated back from the web system to the actual RFID hardware device and configures the device for specific inventory interrogation. This can occur from cloud services or local area network.

The data grid in the inventory page consists of magnifying glasses in the last column under the title “Find”. When the magnifying glass icon is clicked the system automatically navigates to the real-time “Visual Locator” 400 page.

The “Visual Locator” page indicates the “Current Location” 410 with the zone name (AdminProc) and “Tracking/Monitoring” 430 shows the current selected tag EPC/Tag ID which indicates the tag that is being monitored for visual animated display in real-time.

The label “duration” 420 indicates the time span of tag monitoring in days: hours: min: seconds. By selecting the tag icon 440 in the tree list the floorplan will reveal the real-time current location of that tag.

Real-time monitoring of all tags is still occurring; however, when selecting a tag the user will only get a visual animated indication of all transit moves from the tag selected from the Inventory Page's data grid magnifying glass icon. All other transits and interrogation as they occur are being saved to the database which can be selected as single select or multiple select to view all historical transits and movement of tags.

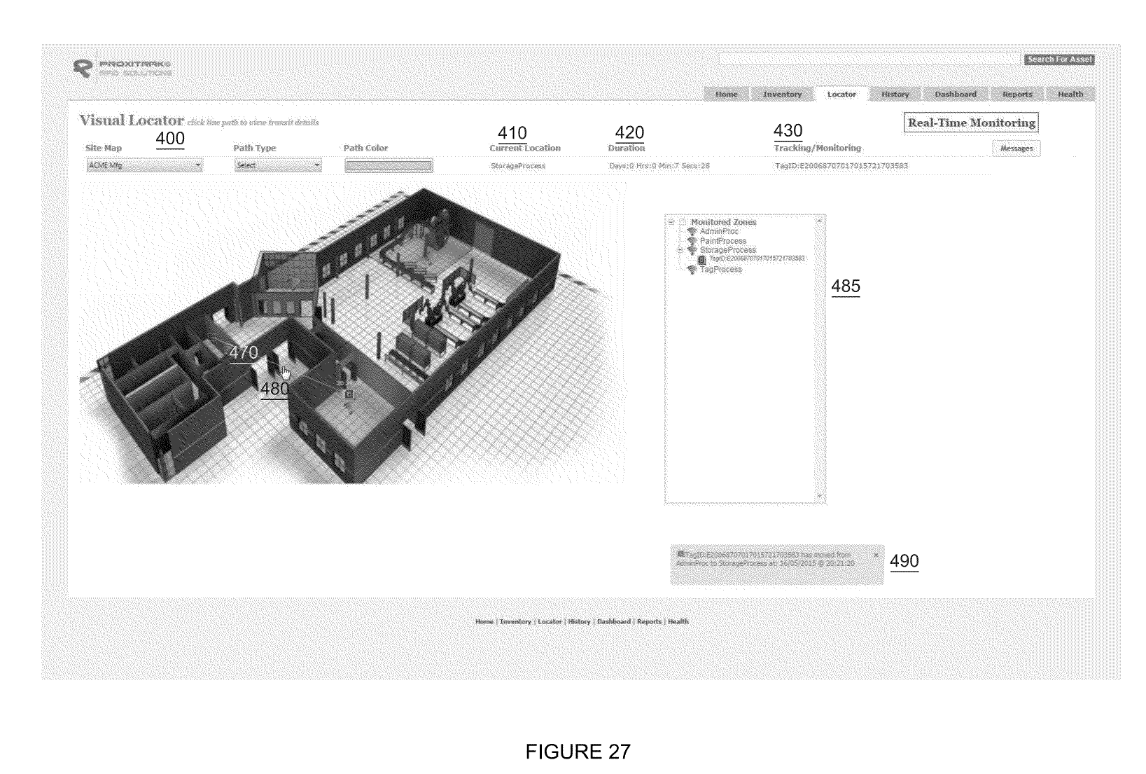

Anytime a user views the Visual Locator page the current monitored tag will be monitored in real-time and any movement of the monitored tag will be indicated by an animated line 470 as indicated in FIG. 27. When a user clicks on the animated line 480 a blue pop-up dialog 490 will appear indicated details about the tag transition as indicated in FIGS. 27 & 28. The EPC/Tag ID and Tag icon will all traverse the tree view list 485 in real-time to indicate the corresponding zone location at the time the tag moves between zones.

A user can select the History page where a grid data 500 will show historical data only in 18 row increments at a time. Scrolling down with the scrollbar 510 located at the right side of the grid view will load more events as needed.

This feature is called “Load on Demand” and ensures efficient data retrieval and manipulation of the data in the grid view. the user can enter specific EPC entered into the data grid's EPC filter box 505 in the data grid header indicated a desire to “play back” all historical transitions and events associated with that particular EPC.

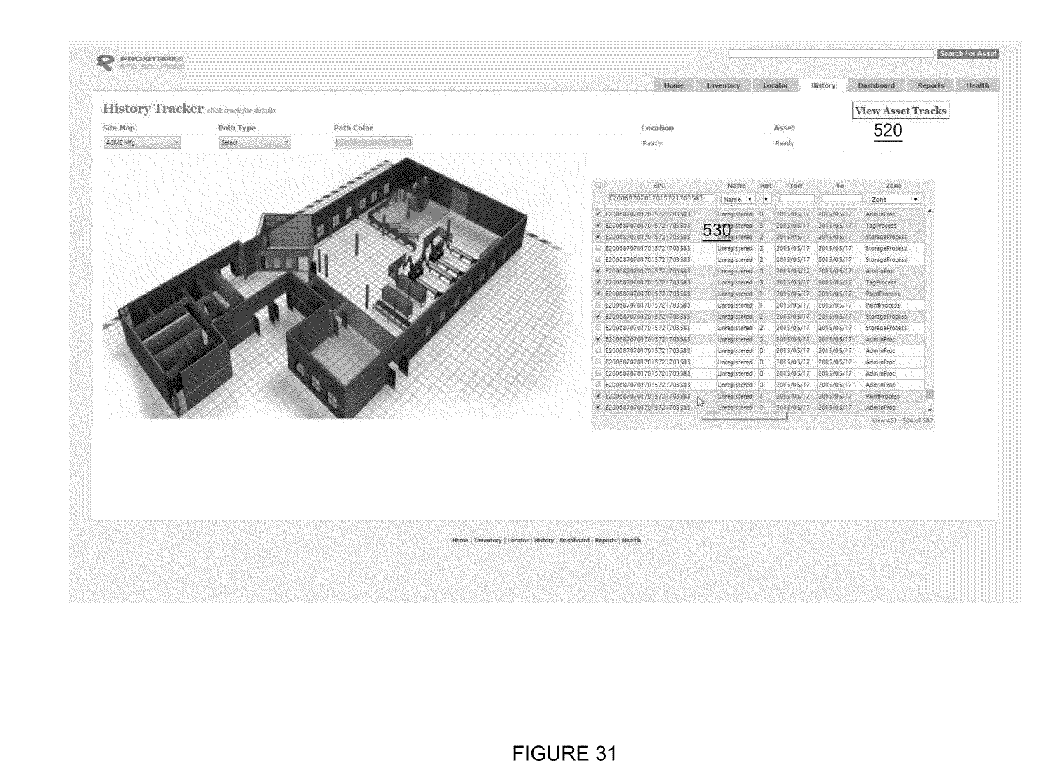

As shown in FIG. 31 a user can select a single or multiple rows 530 and all selected items are highlighted in yellow. When the user clicks the View Assets button 520 an animated historical “play-back” tag transition will occur.

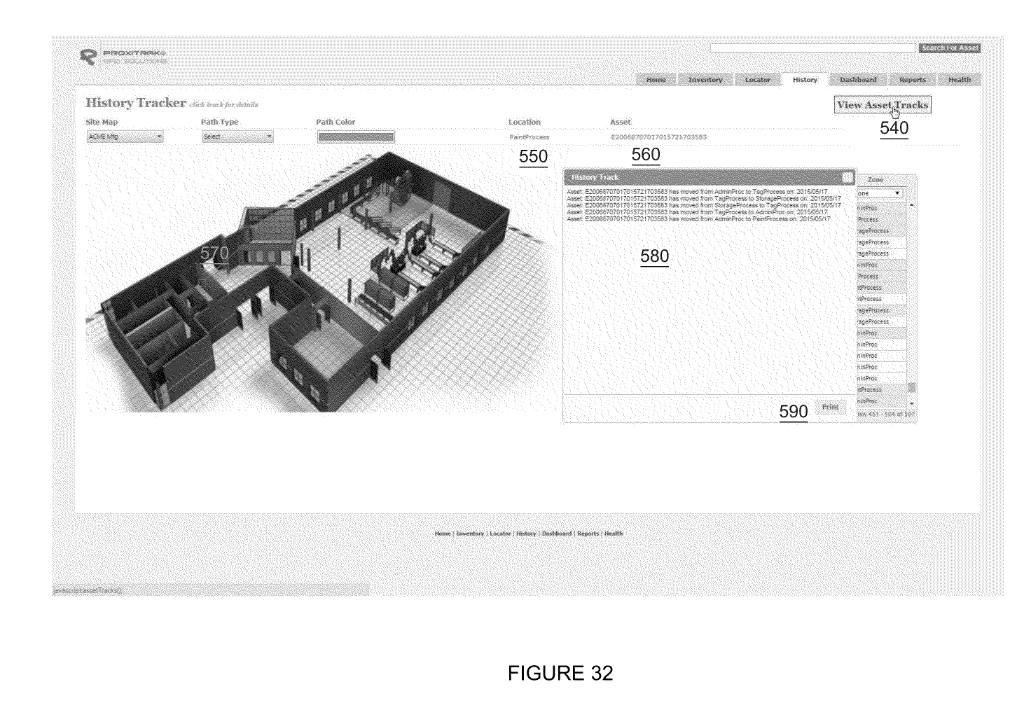

In FIG. 32, one of the “play-back” track routes 570 are visible in green indicating a historical movement from the AdminProc zone to the Paint Shop zone. When selecting multiple tags the system will animate the transition path history of each selected row at a predetermined interval until the all selected rows have been animated and displayed. Notice that the “Current Location” 550 indicates the history's origin and destination locations and a “play-back” list window 580 pops-up showing movement detail as it occurred in history. The Historical “play-back” list can be printed as needed 590. The user can select the system Health Monitoring page to monitor the accuracy, efficiency or strength of the RFID infrastructure signals. The health monitor, presents real-time current signal strength status of each reader connected to the selected reader.

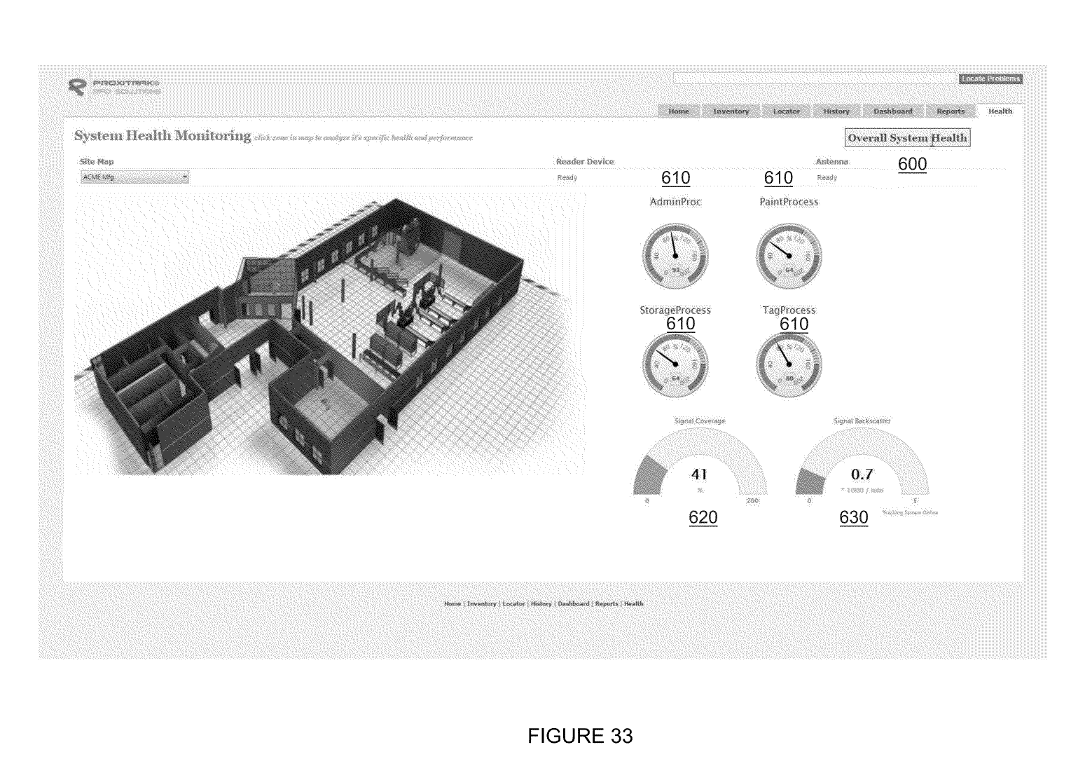

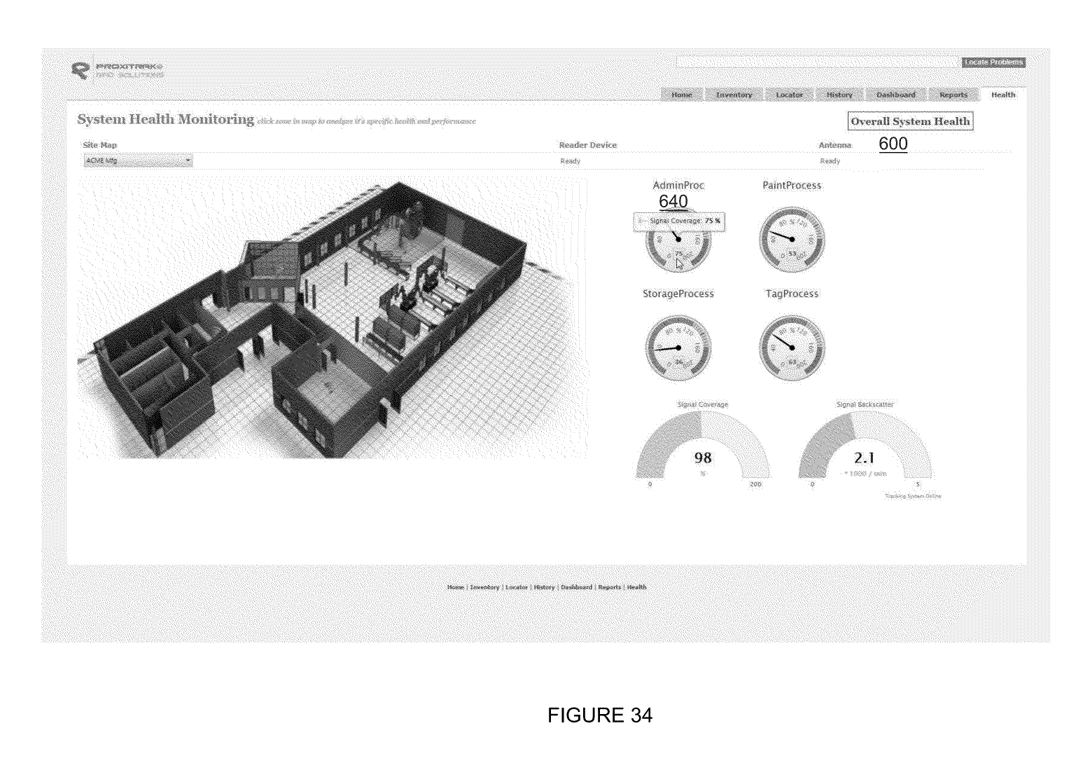

The System Health and Monitoring page shows four small gauges 610 that represent zones and two large gauges, one Signal Coverage 620 and one Back Scatter 630, that represent the entire site as shown in FIG. 33. Each small (Zone) gauge 610 represents the current, live real-time RSSI strength of the antenna associated with that zone.

The maximum value is set by the “Set Max Power” option from the from the Optimization and Layout Management feature in the designer tool. The large Back Scatter gauge 630 represents the current, live real-time measurement of the modulated scattered electromagnetic wave incident from the reader. This is device specific.

The large Signal Coverage gauge 620 represents the current, live real-time measurement of read success demonstrated over the entire site area.

The RSSI value for indicated by the small gauge (in this example the AdminProc gauge 640) zone when the user places the cursor over the gauge. The user can click on the zone overlay image 650 (the example in this case is the small Admin Proc zone highlighted in the yellow dotted line 650). When the zone is clicked the page will change to show a larger RSSI gauge 660, Signal Coverage gauge 680, Backscatter Gauge 690, Real-Time RSSI performance gauge 670 and tag list box 700 for the selected zone. All gauges are animated with real-time live data pushed from the RFID reader hardware device.

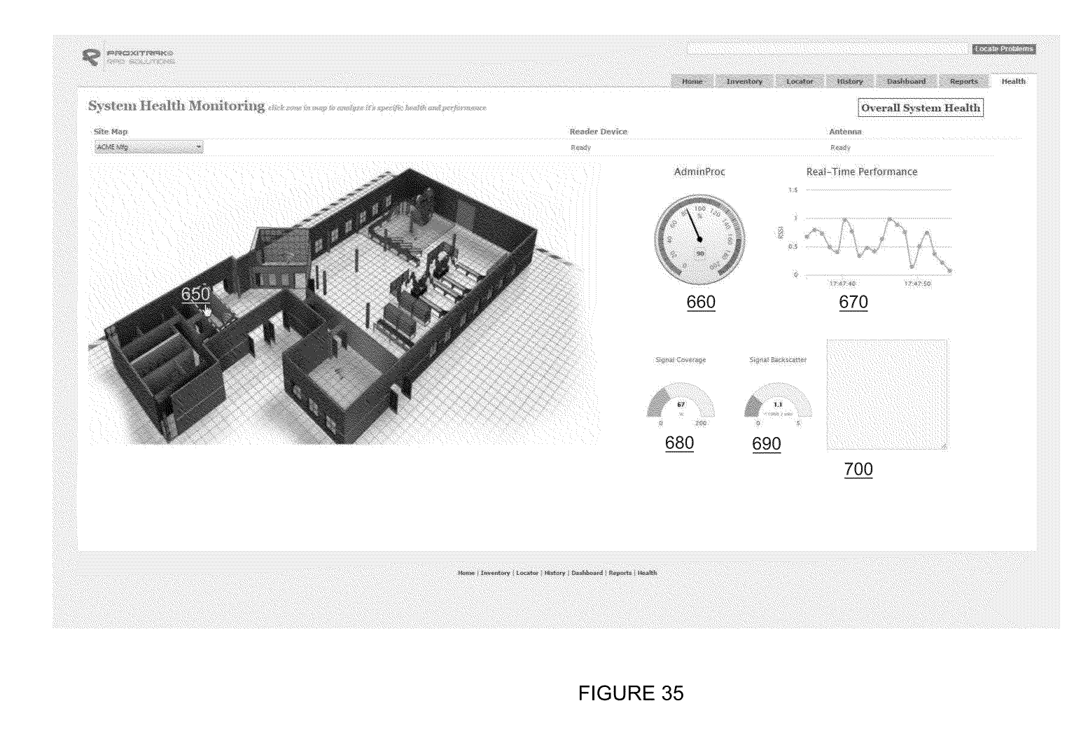

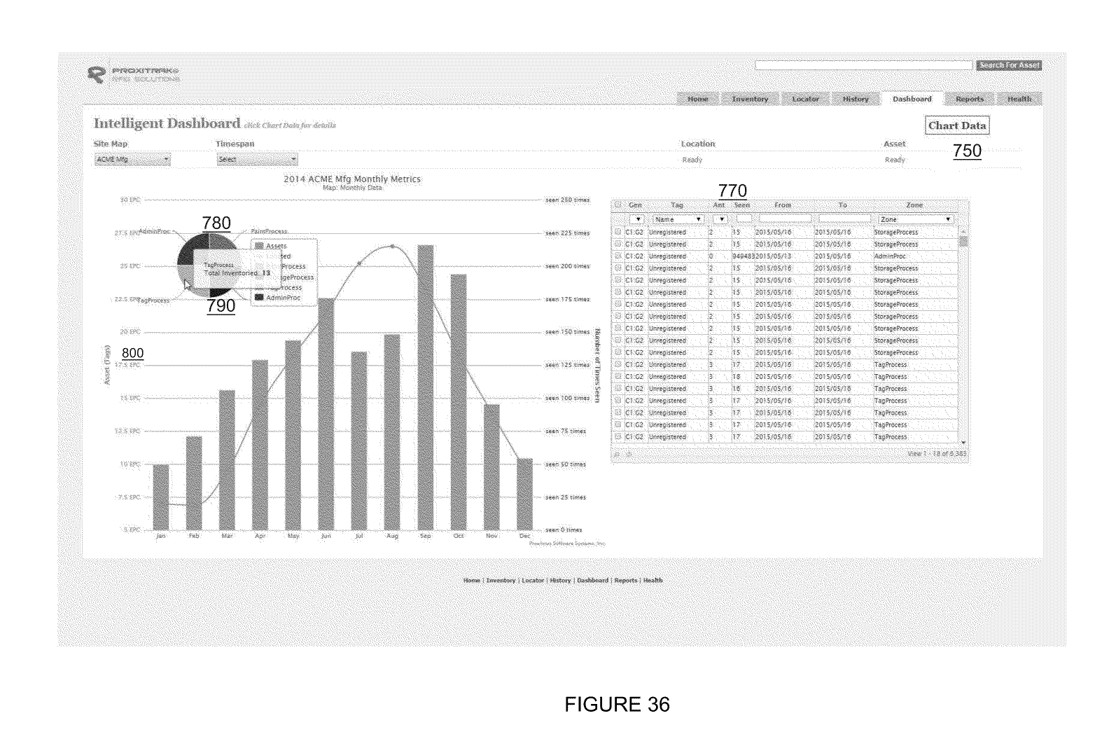

FIG. 35 shows an example of an intelligent dashboard data grid 750. It is used to show real-time metrics of tag data that are currently being monitored. User-selectable objects and interactive buttons display key performance indicators and total tracking performance figures 770 of a previous CAD design. The dashboard pie chart 780 shows metrics from individual zones, including total inventors invoked against specific zones. The pie chart legend 790 shows real-time color association and labels for various graphs and embedded charts. The vertical axis 800 shows total Electronic Product Code (EPC) reads.

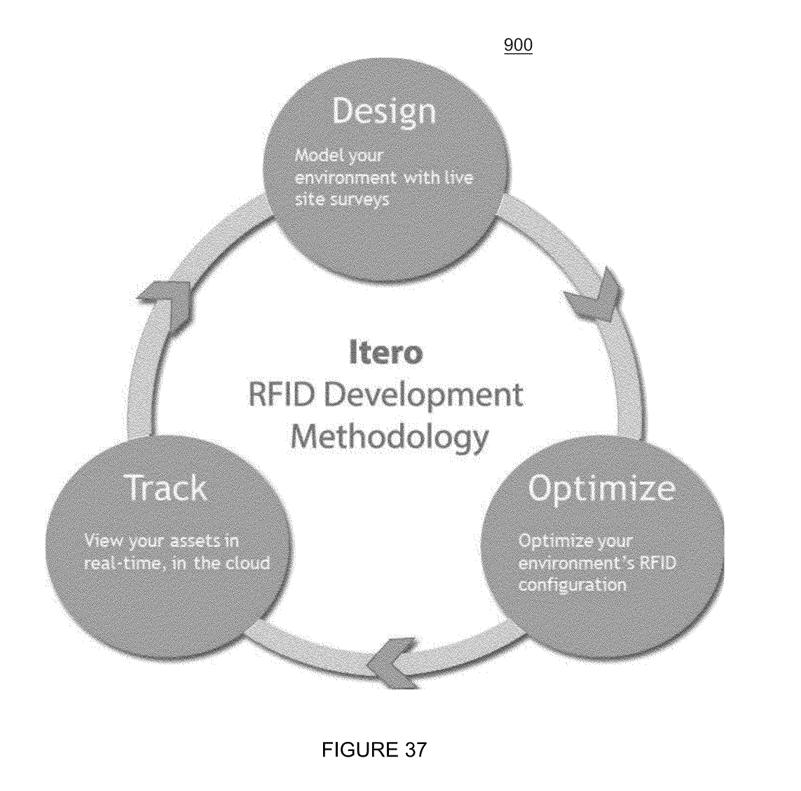

FIG. 37 is a diagram 900 of the methodology to develop RFID systems through repeated cycles, and in incremental sections per cycle. This promotes indoctrination during the early stages of RFID development when building parts or versions of the system. The goal is to initiate key indicators in the RFID development, leveraging a subset of the RFID asset tracking requirements, and iteratively improve and optimize the evolving versions until the full system is implemented.

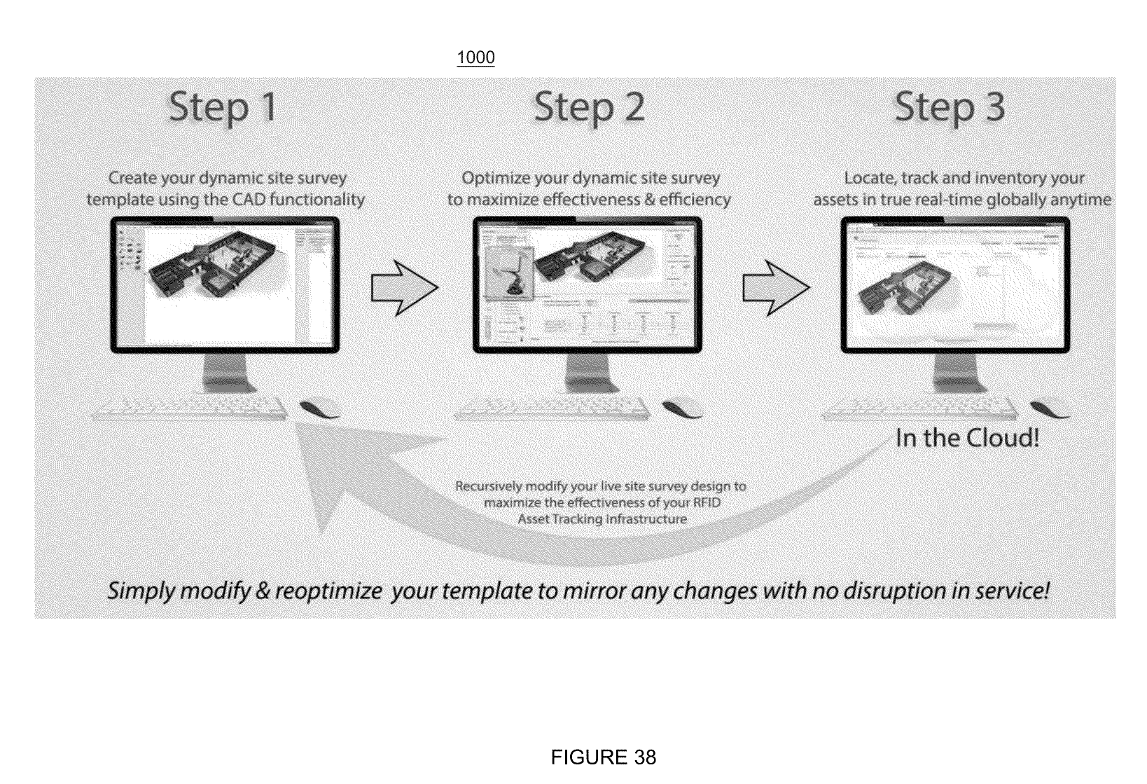

FIG. 38 is another diagram of the three-step process 1000 underlying the present invention. This process allows the user to iteratively or recursively keep the tracking environment current at all times, regardless of constantly changing business requirements. Accordingly, in several embodiments, the present invention (1) provides a desktop application connected to one or more RFID reader devices, (2) provides a list of available antennas autonomously, (3) provides an import of floor plan images and the ability to superimpose/draw overlays over imported images, (4) provides for the assignment of available RFID antennas to previously drawn zones/overlays; (5) sends the saved image and data to an XML file (which may be sent via TCIP or HTTP to an IIS web server as XML file, where web server redraws the image from the XML), (6) provides real time updates, through a web-based software system, of tag movement through autonomous creation and drawings of lines and squares; (7) allows the user to click on any real-time object revealing the exact asset that moved and the time it moved; (8) provide grid views that allow any row of grid data, once selected, to depict the visual path representing movement of the tagged asset between zones.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for designing an asset tracking plan, comprising the steps of:
receiving, using a processor or microprocessor in a computing device, a graphical file representing the floor plan of a space containing assets to be tracked, said assets marked or affixed with RFID tags;
defining one or more contiguous areas within said space as zones;
placing one or more antenna icons within one or more of said zones; and
setting RF field strength and rotation for each of said one or more antenna icons.

2. The method of claim 1, wherein the floor plan with zone and antenna information is saved as a computer file on a non-transitory computer-readable storage medium.

3. The method of claim 1, wherein the floor plan represents an office space.

4. The method of claim 1, wherein the assets to be tracked are moved within the space.

5. A system for designing an asset tracking plan, comprising:
a computing device with a processor or microprocessor coupled to a computer memory, wherein the processor or microprocessor is programmed to
receive, using a processor or microprocessor in a computing device, a graphical file representing the floor plan of a space containing assets to be tracked, said assets marked or affixed with RFID tags;
define one or more contiguous areas within said space as zones;
place one or more antenna icons within one or more of said zones; and
set RF field strength and rotation for each of said one or more antenna icons.

6. The system of claim 5, wherein the floor plan with zone and antenna information is saved as a computer file on a non-transitory computer-readable storage medium.

7. The system of claim 5, wherein the floor plan represents an office space.

8. The system of claim 5, wherein the assets to be tracked are moved within the space.

9. A system for tracking assets with attached RFID tags, comprising:
one or more RFID readers in a space;
a plurality of polarized antennae in said space; and
at least one computing device in communication, wired or wireless, with said one or more RFID readers, said computing device comprising a microprocessor or processor adapted to import and display a graphical floor plan representative of the space with locations of the RFID readers or antennas, or both, indicated thereon.

10. The system of claim 9, further wherein said microprocessor or processor is adapted to receive RFID tag location information from said one or more RFID readers.

11. The system of claim 10, further wherein said microprocessor or processor is adapted to display in real time the movement of assets and associated RFID tags within the space.

12. The system of claim 9, wherein the floor plan represents an office space.

13. The system of claim 10, further wherein said microprocessor processor is adapted to store historical movement information of assets and associated RFID tags within the space.

14. The system of claim 13, further wherein said microprocessor or processor is adapted to display the historical movement of assets and associated RFID tags within the space.
